(19) United States
(12) Patent Application Publication
(10) Pub. No.: US 2025/0135426 A1
(43) Pub. Date: May 1, 2025

(54) INORGANIC NON-METALLIC NANOPARTICLE-ASSEMBLED HYDROGEL MATERIAL AND APPLICATION THEREOF IN ADDITIVE MANUFACTURING TECHNOLOGY

(71) Applicant: DALIAN UNIVERSITY OF TECHNOLOGY, Dalian, Liaoning (CN)

(72) Inventors: Huanan WANG, Dalian, Liaoning (CN); Zhenzhen DOU, Dalian, Liaoning (CN); Kaiwen CHEN, Dalian, Liaoning (CN); Xin LI, Dalian, Liaoning (CN); Chuanbo GONG, Dalian, Liaoning (CN); Kai SUN, Dalian, Liaoning (CN)

(21) Appl. No.: 18/564,237

(22) PCT Filed: Nov. 30, 2021
(86) PCT No.: PCT/CN2021/134538

§ 371 Date: Nov. 27, 2023

(30) Foreign Application Priority Data
May 31, 2021 (CN) 202110601607.5

(51) Int. Cl. B01J 13/00; B33Y 10/00; B33Y 50/00; B33Y 70/10; B33Y 80/00

(52) U.S. Cl. CPC B01J 13/0052; B33Y 10/00; B33Y 50/00; B33Y 70/10; B33Y 80/00

(57) ABSTRACT

The present invention relates to the field of materials science, the field of nanomaterials, and the field of biomedical engineering, and in particular to an inorganic non-metallic nanoparticle-assembled hydrogel material and an application thereof inl additive manufacturing technology. The hydrogel material is assembled from inorganic non-metallic particles, so as to form a hydrogel network; the size of the inorganic non-metallic particles ranges from 10 nm to 20 um; the inorganic non-metallic particles account for 2-80 wt % of the total mass of hydrogel; and the hydrogel network has microscopic pores having a pore size ranging from 0.1 um to 30 um. The inorganic non-metallic particles are assembled into a hydrogel material by an electrostatic assembly method or a hydrophobic action assembly method or a magnetic action assembly method. The hydrogel material is additively manufactured to obtain a gel scaffold which is used as a bone repair scaffold or a cartilage repair scaffold. The hydrogel material of the present invention is directly applied to inorganic non-metallic additive manufacturing technology, without using an additive or a cross-linking agent.

### TECHNICAL FIELD

The present invention belongs to the fields of materials science, nanomaterials, and biomedical engineering, and relates to a printable inorganic non-metallic gel ink raw material formed by bioactive inorganic non-metallic particles by means of electrostatic interaction, hydrophobic interaction and magnetic force effect, further relates to the preparation of scaffolds by means of additive manufacturing using 3D printer technology and applications thereof.

### BACKGROUND

Diseases such as tissue and organ defects or dysfunction have become one of major causes for harm to human health, and “tissue engineering” focusing on artificial tissues and organs thus came into being. After more than 30 years of development, tissue engineering has played an increasingly important role in tissue or organ repair treatment. Tissue engineering contains three basic elements: stent materials, bioactive molecules and seed cells. As important constituents of tissue engineering, stent materials provide cells with spatial structures and growth templates for adhesion, proliferation and differentiation, and can induce tissue regeneration. Stent materials must have good biological activity, compatibility and inducibility in terms of engineering, and need to provide temporary mechanical support for different parts or functions. At present, traditional stent preparation methods, such as pore-forming agent method, freeze-casting method, gas foaming method, and organic foam impregnation method, suffers the following defects: (i) complex preparation process and poor reproducibility, (ii) difficult to accurately control size, shape and pore distribution of the stents; and (iii) solvent residues, reducing application value of the stents in subsequent experiments. Additive manufacturing allows precise control of internal pore structure of porous structures, thereby permitting the fabrication of complex geometries with reproducibility, and additively manufactured stents have attracted great interest in the field of tissue engineering.

Additive manufacturing, also known as rapid prototyping manufacturing or solid freeform fabrication or 3D printing, has become a promising manufacturing technology in different fields, including biomedical research. Design a model scaffold through the computer-aided design (CAD), export the designed model scaffold as a standard 3D printing language file (stl. file), import the stl.file to slicing software to cut the model according to a route, and then use a 3D printer to additively manufacture a model scaffold. Printing methods are divided, according to different raw material, into photo-curing printing, selective laser sintering, extrusion printing, stereolithography printing, inkjet printing, laser melting deposition, and the like, and the printed scaffold is generally post-processed to remove excess material or is subject to sintering treatment to obtain higher mechanical strength. Based on an accurate three-dimensional defect model formed after CT scanning, an ideal scaffold that perfectly fits a specific defect can be then printed out, thus providing huge potential for personalized clinical medicine. Through the additive manufacturing technology, strict control over the structures can be realized, thereby guaranteeing reproducibility and supporting scale and standardization.

Metal materials, polymer materials, and inorganic non-metallic materials can be used for scaffolds in the tissue engineering. Metal materials are generally inert and non-degradable, so they have to be taken out again after being implemented in the human body, which will cause secondary harm to patients. Due to weak mechanical properties, polymer materials are hard to support the repair of load-bearing damaged tissues and organs, while inorganic non-metallic materials can control the biological activity, mechanical properties, degradability and other characteristics of the scaffold by adjusting the composition and crystalline state, and can be directly applied to the human body or the biology, application, biochemistry and other fields directly related to the human body. In the physiological environment of the human body, inorganic non-metallic scaffolds are capable of stimulating special cellular responses at a molecular level, absorbing active substances related to tissue repair, and releasing bioactive ions (such as Ca, Mg, Sr, Si, B, Fe, Cu, Zn, Cr and other element ions) which are used to induce changes in cell phenotypes or regulate an immune microenvironment to guide tissue healing and regeneration. Furthermore, inorganic non-metallic scaffolds can also react with hosts (cells, body fluids and tissues) through a surface microstructure, regulate spontaneous repair function of a body, induce and promote new bone formation, which are bioactive scaffold materials featuring “adjustable biological response characteristics” and “active repair function”. Using inorganic non-metallic scaffolds as tissue engineering scaffolds can create better excellent tissue or organ repair effect.

At present, methods for preparing inorganic non-metallic scaffolds usually mix inorganic non-metallic particles and printable polymers in a certain proportion to form shear-thinning slurry, and scaffolds are then manufactured through 3D printing with the slurry, followed by being sintered at a high temperature to remove plasticizers. For example, in the Chinese patent with Application No. CN201710347623.X, bioceramic powder, degradable metal powder, bioglass combustion improver powder and binder solution are mixed together to obtain a slurry, which is degreased and sintered in an oxygen-free environment after 3D printing. A mixture of various components is highly susceptible to uneven mixing at the early stage, thus resulting in low printing accuracy, uneven structure after sintering, and the like. Lei Chen et al. (Biomaterials, 2019, 196: 138-150) use inorganic non-metallic powder containing calcium silicate lithium elements with alginic acid and pluronic as a plasticizer to configure printing ink, the scaffolds printed thereby have excellent bone-forming properties, but a sintering and curing process of these printed scaffolds is set above 1000° C. due to the presence of the plasticizer. Using the plasticizer as a additive to print the inorganic non-metallic scaffolds will lead to incomplete sintering of additives and uneven pore structure, which is easy to cause stress concentration and may result in sharp decline in mechanical properties. Therefore, it is necessary to design a new additive manufacturing method for inorganic non-metallic materials from the perspective of material design.

### SUMMARY

An objective of the present invention is to solve the shortcomings that additives are required for plasticization when printing is made with pure inorganic non-metallic materials, and to prepare, based on the additive manufacturing technology, inorganic non-metallic materials with high strength that can be used for 3D printing by a simple and effective method. Bioactive inorganic particles are used to generate high-strength gel ink through electrostatic interaction, hydrophobic interaction and magnetic force effect, and the gel ink also have strong recovery ability after damage. The strength of the gel ink is controllable within the range of 10 Pa-500 kPa. The gel ink prepared has good printing performance, and 3D scaffolds are manufactured through the integration of modeling software, slicing software and a 3D printer. The printed scaffolds can be subject to heat treatment according to the application requirements, but do not need to be processed above 1000° C.; and the resulting scaffold structure is uniform, with adjustable macroscopic pores and microscopic pores, and a compressive strength can reach 70 MPa, which can be applied to tissue engineering or electronic devices. Regarding the application in tissue engineering, the scaffolds can be used as bone repair scaffolds, cartilage repair scaffolds, and scaffolds loading bioactive protein drugs, bioactive substance drug molecules or mesenchymal stem cells, endothelial cells or schwann cell; regarding the application in electronic devices, the scaffolds can be used as supercapacitors, batteries, solar cells, piezoelectric sensors, optoelectronic sensors, chemical sensor, biosensors, and electronic skin sensors, providing new design ideas for the additive manufacturing of inorganic non-metallic materials.

The present invention uses the following technical solution:

The present invention provides an inorganic non-metallic nanoparticle-assembled hydrogel material which is assembled from inorganic non-metallic particles to form hydrogel network. The size of the inorganic non-metallic particles ranges from 10 nm-20 μm. The inorganic non-metallic particles account for 2-80 wt. % of the total mass of hydrogel material. The hydrogel network has microscopic pores having a pore size ranging from 0.1 μm-30 μm.

In the above technical solution, further, the hydrogel material has mechanical support strength of 100 kPa-400 kPa, viscosity of 2000-10000 Pa·s, and recovery ability after damage of 50%-100%.

In the above technical solution, further, the inorganic non-metallic particles are one or a combination of several particles of silicon dioxide particles, bioglass particles, clay particles, calcium sulfate particles, calcium carbonate particles, hydroxyapatite particles, iron oxide particles, zirconia particles, zinc oxide particles, titanium oxide particles, aluminum oxide particles, barium titanate particles, silicon carbide particles, graphene, graphene oxide, reduced graphene oxide, transition metal carbide or nitride (MXene), transition metal disulfide (TMD), hexagonal boron nitride and black phosphorus nanosheets, and the transition metal disulfide is preferably MoS₂.

In the above technical solution, further, the preparation method of the hydrogel material is an electrostatic assembly method or a hydrophobic interaction assembly method or a magnetic interaction assembly method.

The electrostatic assembly method includes the following steps of:
S1. preparing negatively charged inorganic non-metallic particles by using one or more of a sol-gel method, a chemical precipitation method, a melting method, a hydrothermal method, a template method, a chemical stripping method, an electrochemical stripping method, and a mechanical stripping method, dispersing the obtained negatively charged inorganic non-metallic particles in a liquid solvent containing deionized water, preparing a particle suspension with a mass fraction of 1%-80%, and fully stirring for 2-8 h;
S2. adding the inorganic non-metallic nanoparticles to a solvent of one or a combination of methanol, ethanol, isopropanol, butanol or acetone to prepare a 1%-50% suspension, and stirring for 20-60 min and then adding water-soluble positively charged groups to react for 6-12h, where the positively charged groups are amino groups in aliphatic amines, imine in nitrogen-nitrogen disubstituted amidine groups, or imine compounds in guanidine groups substituted by tetranitrogen, followed by centrifuging and washing to obtain positively charged inorganic non-metallic particles, dispersing the positively charged inorganic non-metallic particles in deionized water or in one or two of liquid solvents of methanol, ethanol, acetone and isopropanol to prepare a particle suspension with a mass fraction of 1%-80%, and fully stirring for 2-8 h to obtain a positively charged inorganic non-metallic particle suspension;
S3. adding the negatively charged inorganic non-metallic particle suspension to the positively charged inorganic non-metallic particle suspension, where a number ratio of the negatively charged particles to the positively charged particles in suspension is 1:0-0:1, preferably 10:1-1:50, and more preferably 5:1-1:10, to obtain a precursor solution after stirring evenly; and
S4. adding 5 mM-25 mM of an acidic solution consisting of one or more of acetic acid, phosphoric acid, hydrochloric acid and nitric acid to the precursor solution obtained in the step S3 while stirring, continuing stirring for 0.5-3 h and then centrifuging at a speed of 2000 g-10000 g for 20-40 min, and obtaining, after removing supernatant, a gel ink raw material with a solid phase content of 2-80 wt. %, which is the hydrogel material.

The hydrophobic interaction assembly method includes the following steps of:
S1. preparing negatively charged inorganic non-metallic particles by using one or more of a sol-gel method, a chemical precipitation method, a melting method, a hydrothermal method, a template method, a chemical stripping method, an electrochemical stripping method, and a mechanical stripping method, dispersing the negatively charged inorganic non-metallic particles in absolute ethanol to prepare an inorganic non-metallic particle suspension with a concentration of 1%-8%, stirring for 20-60 min, then adding one or a combination of silicon-halogen bond compounds containing hydrophobic groups, silane coupling agent, or stearic acid compounds, reacting for 6-12 h, followed by centrifuging and washing to obtain hydrophobic inorganic non-metallic particles, and dispersing the hydrophobic inorganic non-metallic particles in deionized water or in one or two of liquid solvents of methanol, ethanol, acetone and isopropanol to obtain a dispersion of the hydrophobic inorganic non-metallic particles; and
S2. centrifuging the dispersion of the hydrophobic inorganic non-metallic particles at a speed of 2000 g-10000 g for 20-40 min, and obtaining, after removing supernatant, a gel ink raw material with a solid phase content of 2-80 wt. %, which is the hydrogel material.

The magnetic interaction assembly method includes the following steps of:

Preparing magnetic particles by using one or more elements of iron, cobalt and nickel, dispersing the magnetic particles in deionized water or in one or two of liquid solvents of methanol, ethanol, acetone and isopropanol to obtain a suspension of the hydrophobic inorganic non-metallic magnetic particles with a concentration of 1%-80%, where the magnetic particles are oriented and assembled into a uniform network structure under the action of a magnetic field of 10-300 A/m, then centrifuging the assembled suspension at a speed of 2000 g-10000 g for 20-40 min, and obtaining, after removing supernatant, a gel ink raw material with a solid phase content of 2-80 wt. %.

In a second aspect, the present invention provides an inorganic non-metallic nanoparticle-assembled hydrogel material used as bone-filling biomedical materials for injectable, shapeable and drug sustained-release carriers, where the inorganic non-metallic nanoparticles constituting the hydrogel are one or a combination of several particles of bioglass particles, clay particles, calcium phosphate particles and bioactive ceramic particles, a size of the inorganic non-metallic nanoparticles is 10 nm-20 μm, and the inorganic non-metallic nanoparticles account for 2-80 wt % of the total mass of the hydrogel.

In a third aspect, the present invention provides an inorganic non-metallic gel scaffold which is obtained through additive manufacturing the hydrogel material. The gel scaffold has interpenetrating pores formed by stacking fibers, with a pore diameter of 50-1000 μm, and a porosity of 20%-80%; a surface of the scaffold fiber has microscopic pores, with a pore diameter of 3-80 nm, a specific surface area of 50-500 m²/g, and a fracture mechanical strength of 2-25 MPa.

In the above technical solution, further, the preparation method of the gel scaffold includes the following steps of:
(1) using the gel ink raw material obtained by the abovementioned method as 3D printing ink;
(2) designing model: building a model using modeling software, and performing layered slicing processing on the built model using slicing software;
(3) performing 3D printing to form a target model green body: inputting the designed model into a printer, setting the number of printing lines and printing speed of each layer of the designed model, loading the gel ink raw material in a syringe of the printer for layer-by-layer printing, and finally forming the gel model green body; and
(4) performing heat treatment: placing the gel model green body into a sintering furnace and adjusting the sintering temperature to obtain a corresponding customized 3D porous inorganic non-metallic scaffold.

In the above technical solution, further in the step (3), the 3D printer prints fibers with a diameter ≥160 μm, a printing layer height >300 μm, and a printing speed of 0.5 mm/s-20 mm/s.

In the above technical solution, further in the step (4), the treatment temperature of the heat treatment process is determined according to properties of the scaffold, which is dried at 20-50° C. for 8-24 h and sintered at 300-1500° C. for 2-72 h, with a heating rate of 0.5-10° C./min.

In a fourth aspect, the present invention provides an application of the inorganic non-metallic gel scaffolds in tissue engineering or electronic devices. Regarding the application in tissue engineering, the inorganic non-metallic gel scaffolds can be used as bone repair scaffolds, cartilage repair scaffolds, and scaffolds for loading bioactive protein drugs, bioactive substance drug molecules or mesenchymal stem cells, endothelial cells or schwann cell scaffolds. Regarding the application in electronic devices, the inorganic non-metallic gel scaffolds can be used as supercapacitors, batteries, solar cells, piezoelectric sensors, optoelectronic sensors, chemical sensors, biosensors, and electronic skin sensors.

### Beneficial Effects of the Present Invention

(1) The present invention provides a process for customizing the preparation of inorganic non-metallic scaffolds using inorganic non-metallic particles as basic unit, and the preparation method is simple and convenient, having high application value for industrial mass production.

(2) The present invention utilizes the electrostatic interaction, hydrophobic interaction and magnetic interaction between inorganic non-metallic particles to form inorganic non-metallic gel ink and realizes the gelation of inorganic non-metallic materials under normal temperature conditions, featuring precise adjustability of mechanical properties within the range of 10 Pa-500 kPa, and controllable viscosity within the range of 2000 Pa·s-10000 Pa·s. It can be directly applied to inorganic non-metallic additive manufacturing technology without additives or crosslinking agents.

(3) Using the 3D scaffolds prepared by the inorganic non-metallic gel ink, the present invention realizes the high-precision printing of inorganic non-metallic materials, with a pore size up to 70 μm. The present invention also realizes the printing of scaffolds with complex structures, and can realize the fixing of the inorganic non-metallic scaffolds without a high sintering temperature, realizing low-cost additive manufacturing.

(4) The 3D scaffolds customized by the present invention feature strong strength, have a compressive strength up to 70 MPa and a compression modulus up to 500 MPa, such that the scaffolds can fully meet the mechanical requirements for cell culture or tissue repair or tumor treatment or electronic devices.

(5) The 3D scaffolds customized by the present invention have interpenetrating macroscopic macropores and a uniform surface microporous structure. The macroscopic macropores are conducive to the ingrowth of tissues and blood vessels, and the uniform surface microporous structure is more conducive to cell adhesion, growth and differentiation.

### BRIEF DESCRIPTION OF THE DRAWINGS

FIG. 1 is a flow chart of the customized manufacturing of an inorganic non-metallic scaffold according to a method of the present invention, and illustrations are images of a printed 3D scaffold.

FIG. 2 is a transmission electron microscope image of negatively charged silicon dioxide particles with a particle size of 50 nm prepared in Example 1, a scale bar=100 nm.

FIG. 3 is a potential test image of positively charged silicon dioxide particles with a particle size of 50 nm prepared in Example 1.

FIG. 4 is a transmission electron microscope image of negatively charged silicon dioxide particles with particle sizes within 200-300 nm prepared in Example 4, a scale bar=500 nm.

FIG. 5 is a potential test image of positively charged silicon dioxide particles with particle sizes within 200-300 nm prepared in Example 4.

FIG. 6 is a transmission electron microscope image of negatively charged bioglass particles prepared in Example 6, a scale bar=200 nm.

FIG. 7 is a potential test image of positively charged bioglass particles prepared in Example 6.

FIGS. 8A to 8D show microscopic topography images of a printed 3D scaffold in Example 9. FIG. 8A is an electron microscope image of the overall scaffold, FIG. 8B is a surface topography image of fibers of the scaffold, FIG. 8C is an enlarged view of the surface topography of FIG. 8B, and FIG. 8D is an enlarged view of the surface topography of FIG. 8C.

FIG. 9 is a transmission electron microscope image of negatively charged mesoporous bioglass particles prepared in Example 10, a scale bar=100 nm.

FIG. 10 is a potential test image of positively charged mesoporous bioglass particles prepared in Example 10.

FIG. 11A is an image of a 3D scaffold obtained after printing in Example 10, and FIG. 11B is an enlarged view of the scaffold in FIG. 11A, a scale bar=500 μm.

FIGS. 12A and 12B show physical adsorption of the 3D scaffold obtained in Example 10; FIG. 12A is a nitrogen adsorption/desorption curve, and FIG. 12B is a pore size distribution curve.

FIG. 13 is a transmission electron microscope image of negatively charged calcium phosphate particles prepared in Example 13, a scale bar=100 nm.

FIG. 14 shows images of 3D scaffolds with different pore sizes prepared in Example 24 and Micro-CT reconstructed slices thereof, panels A1 to C1 are digital images of printed scaffolds with different pore sizes, panels A2 to C2 are Micro-CT images of scaffolds with different pore sizes, panels A4 to C3 are top views of scaffolds with different pore sizes, panels A4 to C4 are side views of scaffolds with different pore sizes, and panels A5 to C5 are Micro-CT reconstruction images of scaffolds with different pore sizes.

FIG. 15A shows SEM electron microscope images of in-vitro mineralization of 3D scaffolds at different time points in Example 26; in FIG. 15A, panel a1 is a scanning electron microscopy image of printed scaffold fiber, panel a2 is a scanning electron microscope image of the scaffold mineralization on day 0, and panel a3 is a scanning electron microscope image of the scaffold mineralized on day 28, in FIG. 15B shows the distribution of Si, O, Ca, and P elements on the scaffold on day 28.

FIG. 16 is an FTIR analysis chart of in-vitro mineralization of 3D scaffolds at different time points in Example 26.

FIG. 17 is an XDR analysis chart of in-vitro mineralization of 3D scaffolds at different time points in Example 26.

FIG. 18 shows cell viability of MC3T3-E1 mouse embryonic osteoblast precursor cells cultured by using leaching liquor of 3D scaffolds in Example 27.

FIGS. 19A-19C are ALP and Alizarin Red S (ARS) staining and quantitative results of MC3T3-E1 mouse embryonic osteoblast precursor cells cultured in contact with 3D scaffolds within 7 days in Example 27; FIG. 19A shows the ALP and ARS staining of SiO₂ and BG scaffolds, FIG. 19B is a quantitative image of ALP staining, and FIG. 19C is a quantitative image of ARS staining.

FIGS. 20A to 20D is CT scan and histological staining of repairing a cranial parietal bone by using inorganic non-metallic scaffolds in Example 28, which is used to investigate the in-vivo osteogenic activity of the 3D scaffolds; FIG. 20A is a digital photo of an animal model, FIG. 20B is a Micro-CT image of the repair effect of a cranial parietal bone model with SiO₂, BG and Bioss scaffolds at 12 weeks, FIG. 20C is the quantification of a new bone volume of the cranial parietal bone model with SiO₂, BG and Bioss scaffolds at 4, 8 and 12 weeks, and FIG. 20D is the quantification of a width of a new bone trabecula of the cranial parietal bone model with SiO₂, BG and Bioss scaffolds at 4, 8 and 12 weeks.

### DETAILED DESCRIPTIONS OF THE EMBODIMENTS

The following embodiments are only used to illustrate the present invention, and are not intended to limit the present invention in any way.

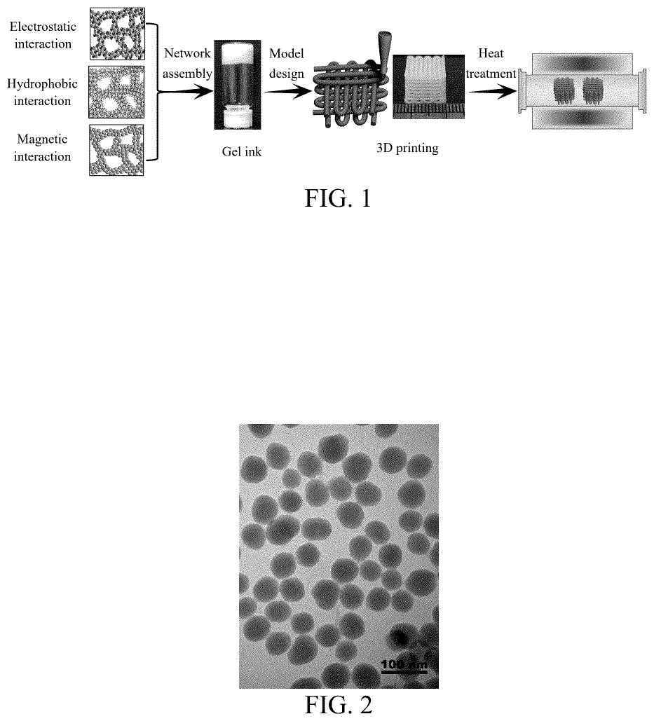

As shown in FIG. 1, it is a flow chart of the customized manufacturing of an inorganic non-metallic scaffold according to a method of the present invention, and illustrations are images of an actual nanostructured bio-ink and extruded three-dimensional scaffold.

The customized manufacturing technology of a bioactive inorganic non-metallic scaffold provided in the present invention will be further illustrated below through the examples in conjunction with the accompanying drawings.

### Example 1

### (1) Preparing 50 nm of Negatively Charged Silicon Dioxide Particles

In this example, silicon dioxide particles with a particle size of 50 nm were prepared by a sol-gel method. First, ethanol and water were mixed evenly, 26.6 mL of ammonia water (25%) was then added and stirred at 800 rpm, and 38.7 mL of tetraethyl orthosilicate was added under the condition of water bath at 25° C. to obtain a solution, and the solution was stirred at a rotational speed of 500 rpm for 5 h for reaction, after completion of the reaction, a resulting reactant was centrifuged and washed with deionized water to obtain negatively charged silicon dioxide particles, which were dispersed in deionized water to prepare a particle suspension with a mass fraction of 10%. FIG. 2 shows that the silicon dioxide particles with a particle size of 50 nm were successfully synthesized, with good uniformity and uniform dispersion among the particles.

### (2) Preparing 50 nm of Positively Charged Silicon Dioxide Particles

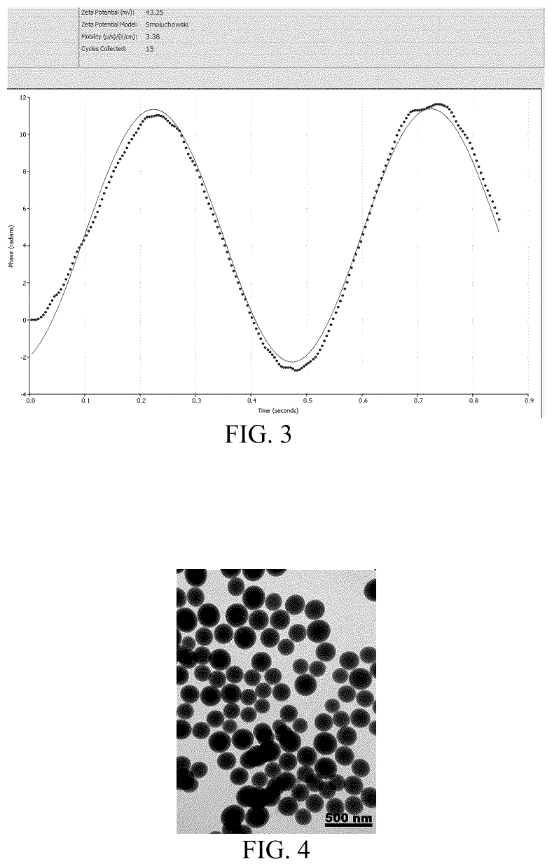

The particle suspension of silicon dioxide with a particle size of 50 nm prepared in the step (1) was centrifuged to obtain precipitate at a lower layer, the precipitate at the lower layer was dispersed in absolute ethanol to prepare 400 mL of a disperse system with a concentration of 10 mg/mL, after being stirred for 30 min, 4 mL of (3-aminopropyl)triethoxysilane was added into the disperse system within 20 min by using a syringe pump, and the disperse system was reacted at room temperature for 8 h under stirring at a speed of 600 rpm. After completion of the reaction, a resulting reactant was washed with deionized water to obtain positively charged silicon dioxide particles, which were dispersed in the deionized water to prepare a particle suspension with a mass fraction of 10%. FIG. 3 shows that surface of the silicon dioxide particles with a particle size of 50 nm were successfully modified with positive charge, and the charge was +35 mv.

### (3) Preparing Gel Ink

The negatively charged silicon dioxide particle suspension with the mass fraction of 10% obtained in the step (1) was added into the positively charged silicon dioxide particle suspension with the mass fraction of 10% obtained in the step (2), a number ratio of the negatively charged silicon dioxide particles to the positively charged silicon dioxide particles in suspension was 1:2, and a precursor solution was obtained after the suspension was evenly stirred; acetic acid was added into the precursor solution, after being continuously stirred for 2 h, the solution was centrifuged at a speed of 8000 g for 25 min, supernatant fluid was then removed to obtain gel ink raw material with a solid phase content of 40 wt. %. Mechanical support strength of the gel ink was measured through the time scanning mode of a rotational rheometer, the recovery ability of the gel ink was measured through a plurality of cycles between continuous strain scanning and time scanning, and the viscosity of the gel ink was measured by changing a shear rate, where a frequency was 1 Hz and a strain was 0.5%, as shown in Table 1.

TABLE 1

| | Mechanical | | Recovery |
|---|---|---|---|
| | support strength | Viscosity | ability |
| Gel ink | 119.7 kPa | 9000 Pa · s | 85% |

### (4) Printing a 3D Scaffold

CAD was used to draw a cube model with a length, width and height of 15 mm, the cube model was input to an extrusion printer, parameters of the extrusion printer were set as follows: the number of printing lines at each layer of 15, a printing speed of 3 mm/s and a height of the printing layer of 15 mm, and a needle with an inner diameter of 500 μm was used; the gel ink raw material prepared in the step (3) was loaded into a syringe of the printer to print out a cube model scaffold. The printing was performed layer by layer to finally form a target model green body.

(5) Performing heat treatment of the model scaffold: the cube model scaffold was put into a sintering furnace and dried at 40° C. for 12 h, the temperature was then raised up to 700° C. at a rate of 5° C./min, and then kept for 4 h to obtain a cured customized inorganic non-metallic scaffold. The sintered 3D scaffold was subject to a compression test using a mechanical testing machine, and a compression rate was 1 mm/min, as shown in Table 2.

TABLE 2

| | Compressive | Modulus of |
|---|---|---|
| | strength | elasticity |
| 3D scaffold | 12 MPa | 15.3 MPa |

### Comparative Example 1 Pure Negatively Charged Silicon Dioxide Particle Ink

The negatively charged silicon dioxide particles prepared in the step (1) of Example 1 were prepared into a suspension with a mass fraction of 10%, acetic acid was then added into the suspension, the suspension was stirred continuously for 2 h and then centrifuged at a speed of 8000 g for 25 min, and supernatant fluid was then removed to obtain gel ink raw material with a solid phase content of 40 wt. %. Mechanical support strength of the ink was measured through the time scanning mode of a rotational rheometer, the recovery ability of the ink was measured through a plurality of cycles between continuous strain scanning and time scanning, and the viscosity of the ink was measured by changing a shear rate, where a frequency was 1 Hz and a strain was 0.5%, as shown in Table 3.

TABLE 3

| | Mechanical | | Recovery |
|---|---|---|---|
| | support strength | Viscosity | ability |
| Gel ink | 1018 Pa | 536 Pa · s | 101% |

### Comparative Example 2 Pure Positively Charged Silicon Dioxide Particle Ink

The positively charged silicon dioxide particles prepared in the step (2) of Example 1 were prepared into a suspension with a mass fraction of 10%, acetic acid was then added into the suspension, the suspension was stirred continuously for 2 h and then centrifuged at a speed of 8000 g for 25 min, and supernatant fluid was then removed to obtain gel ink raw material with a solid phase content of 40 wt. %. Mechanical support strength of the ink was measured through the time scanning mode of a rotational rheometer, the recovery ability of the ink was measured through a plurality of cycles between continuous strain scanning and time scanning, and the viscosity of the ink was measured by changing a shear rate, as shown in Table 4.

TABLE 4

| | Mechanical | | Recovery |
|---|---|---|---|
| | support strength | Viscosity | ability |
| Gel ink | 3420 Pa | 2000 Pa · s | 78% |

It can be identified from Example 1 and Comparative Examples 1 and 2 that the gel ink assembled with opposite charges has higher mechanical support strength, and has a recovery ability of greater than 90% after destruction.

### Example 2

The negatively charged silicon dioxide particles prepared in the step (1) of Example 1 were prepared into a suspension with a mass fraction of 10%, the negatively charged silicon dioxide particle suspension was then added into the positively charged silicon dioxide particle suspension with the mass fraction of 10% obtained in the step (2) of Example 1, a number ratio of the negatively charged silicon dioxide particles to the positively charged silicon dioxide particles in suspension was 3:1, 2:1, 1:1, 1:5 and 1:10 respectively, and a precursor solution was obtained after the suspension was evenly stirred. Acetic acid was added into the precursor solution, after being continuously stirred for 2 h, the solution was centrifuged at a speed of 8000 g for 25 min, supernatant fluid was then removed to obtain gel ink raw material with a solid phase content of 5 wt. %. Mechanical support strength of the gel ink was measured through the time scanning mode of a rotational rheometer, the recovery ability of the gel ink was measured through a plurality of cycles between continuous strain scanning and time scanning, and the viscosity of the gel ink was measured by changing a shear rate, where a frequency was 1 Hz and a strain was 0.5%, as shown in Table 5.

TABLE 5

| | | | | | |
|---|---|---|---|---|---|
| Number ratios of the negatively | 3:1 | 2:1 | 1:1 | 1:5 | 1:10 |
| charged silicon dioxide particles | | | | | |
| to the positively charged silicon | | | | | |
| dioxide particles | | | | | |
| Mechanical support strength (Pa) | 497 ± 94 | 710 ± 293 | 222 ± 175 | 15.7 ± 5 | 0.03 ± 0.02 |
| Viscosity (Pa · s) | 356 ± 15 | 582.6 ± 7 | 134.7 ± 3 | 2.3 ± 0.1 | 0.005 ± 0 |
| Recovery ability (%) | 99.6 | 106.3 | 97.9 | 102.5 | 100.8 |

### Example 3

### (1) Preparing Nanostructured Bio-Ink

The negatively charged silicon dioxide particles prepared in the step (1) of Example 1 were prepared into a suspension with a mass fraction of 10%, the negatively charged silicon dioxide particle suspension was then added into the positively charged silicon dioxide particle suspension with the mass fraction of 10% obtained in the step (2) of Example 1, a number ratio of the negatively charged silicon dioxide particles to the positively charged silicon dioxide particles in suspension was 1:2, and a precursor solution was obtained after the suspension was evenly stirred. Acetic acid was added into the precursor solution, after being continuously stirred for 2 h, the solution was centrifuged at a speed of 8000 g for 25 min, supernatant fluid was then removed to obtain gel ink raw material, with a solid phase content of 5 wt. %, 10 wt. %, 20 wt. %, 30 wt. %, 40 wt. %, 50 wt. % and 60 wt. %, respectively. Mechanical support strength of the gel ink was measured through the time scanning mode of a rotational rheometer, the recovery ability of the gel ink was measured through a plurality of cycles between continuous strain scanning and time scanning, and the viscosity of the gel ink was measured by changing a shear rate, where a frequency was 1 Hz and a strain was 0.5%, as shown in Table 6.

TABLE 6

| Mass fraction | | | | | | | |
|---|---|---|---|---|---|---|---|
| (%) | 5 | 10 | 20 | 30 | 40 | 50 | 60 |
| Mechanical | 0.71 ± 0.3 | 3.5 ± 0.497 | 22.3 ± 3.54 | 101.7 ± 9.4 | 301.6 ± 40.5 | 475.2 ± 20 | 925.88 ± 413.5 |
| support | | | | | | | |
| strength (kPa) | | | | | | | |
| Viscosity | 22.6 ± 7 | 109 ± 23 | 3548 ± 500 | 2535 ± 354 | 20968 ± 3000 | 83120 ± 5000 | 45289 ± 8200 |
| (Pa · s) | | | | | | | |
| Recovery | 106.3 | 100.6 | 99 | 110.5 | 97.6 | 86.5 | 68 |
| ability (%) | | | | | | | |

### Example 4

### (1) Preparing 200-300 nm of Negatively Charged Silicon Dioxide Particles

In this example, silicon dioxide particles with a particle size of 200-300 nm were prepared by the sol-gel method. First, ethanol and water were mixed evenly, 35 mL of ammonia water (25%) was then added and stirred at 900 rpm, and 38.7 mL of tetraethyl orthosilicate was added under the condition of water bath at 25° C. to obtain a solution, and the solution was stirred at a rotational speed of 500 rpm for 30 min for reaction, and then the solution was placed into a refrigerator at 4° for further reaction, after completion of the reaction, a resulting reactant was centrifuged and washed with deionized water to obtain negatively charged silicon dioxide particles, which were dispersed in the deionized water to prepare a particle suspension with a mass fraction of 10%. FIG. 4 shows that the silicon dioxide particles with a particle size of 200-300 nm were successfully synthesized, with good uniformity and uniform dispersion among the particles.

### (2) Preparing 200-300 nm of Positively Charged Silicon Dioxide Particles

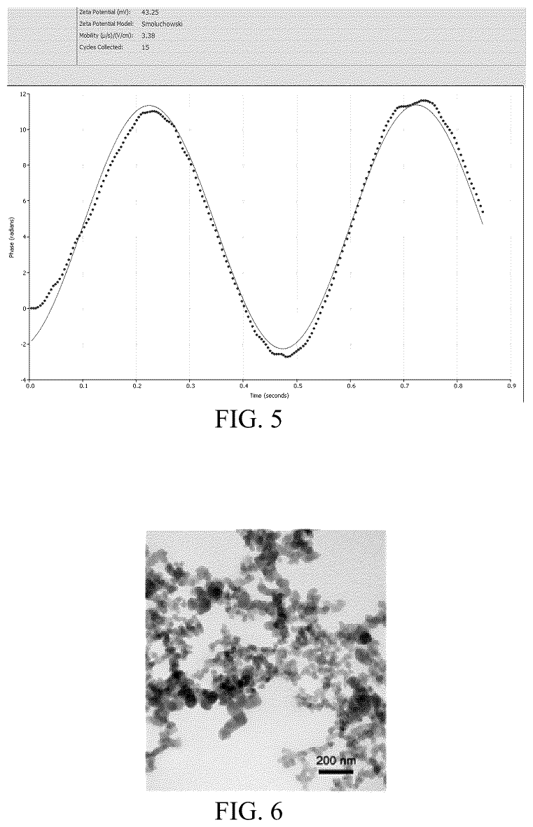

The aqueous dispersion of silicon dioxide with a particle size of 200-300 nm prepared in the step (1) was centrifuged to obtain precipitate at a lower layer, the precipitate at the lower layer was dispersed in methanol to prepare 400 mL of a disperse system with a density of 10 mg/mL, the disperse system was sonicated for 15 min and then was placed in a water bath at 40° C., 2 mM arginine was then added within 20 min by using a syringe pump, and the disperse system was reacted under stirring at a speed of 600 rpm. After completion of the reaction, a resulting reactant was washed with deionized water to obtain positively charged silicon dioxide particles, which were dispersed in the deionized water to prepare a particle suspension with a mass fraction of 10%. FIG. 5 shows that surface of the silicon dioxide particles with a particle size of 300-400 nm were successfully modified with positive charge, and the charge was +27 mv.

### (3) Preparing Gel Ink

The negatively charged silicon dioxide particle suspension with the particle size of 200-300 nm and the mass fraction of 10% obtained in the step (1) was added into the positively charged silicon dioxide particle suspension with a particle size of 200-300 nm and a mass fraction of 10% obtained in the step (2), a number ratio of the negatively charged silicon dioxide particles to the positively charged silicon dioxide particles in suspension was 3:1, 2:1, 1:1, 1:5, 1:10, respectively, and a precursor solution was obtained after the suspension was evenly stirred; acetic acid was added into the precursor solution, after being continuously stirred for 2 h, the solution was centrifuged at a speed of 8000 g for 25 min, supernatant fluid was then removed to obtain gel ink raw material with a solid phase content of 5 wt. %. Mechanical support strength of the gel ink was measured through the time scanning mode of a rotational rheometer, the recovery ability of the gel ink was measured through a plurality of cycles between continuous strain scanning and time scanning, and the viscosity of the gel ink was measured by changing a shear rate, where a frequency was 1 Hz and a strain was 0.5%, as shown in Table 7.

TABLE 7

| | | | | | |
|---|---|---|---|---|---|
| Number ratios of the negatively charged | 3:1 | 2:1 | 1:1 | 1:5 | 1:10 |
| silicon dioxide particles to the positively | | | | | |
| charged silicon dioxide particles | | | | | |
| Mechanical support strength (Pa) | 4.71196 ± | 3.86055 ± | 1.05933 ± | 0.2103 ± | 0.05797 ± |
| | 1 | 0.5 | 0.6 | 0.15 | 0.03 |
| Viscosity (Pa · s) | 3.14651 ± | 2.14951 ± | 0.93924 ± | 0.02246 ± | 0.04158 ± |
| | 0.01 | 0.05 | 0.04 | 0.01 | 0.01 |
| Recovery ability (%) | 102.3 | 96.4 | 97.9 | 90.6 | 86.3 |

### Example 5

### (1) Preparing Gel Ink

The negatively charged silicon dioxide particle suspension with the particle size of 300-400 nm and the mass fraction of 10% obtained in the step (1) of Example 4 was added into the positively charged silicon dioxide particle suspension with the particle size of 300-400 nm and the mass fraction of 10% obtained in the step (2) of Example 4, a number ratio of the negatively charged silicon dioxide particles to the positively charged silicon dioxide particles in suspension was 1:2, and a precursor solution was obtained after the suspension was evenly stirred; acetic acid was added into the precursor solution, after being continuously stirred for 2 h, the solution was centrifuged at a speed of 8000 g for 25 min supernatant fluid was then removed to obtain gel ink raw material with a solid phase content of 500, %, 200, 30%, 40%, 50M and 600, respectively. Mechanical support strength of the gel ink was measured through the time scanning mode of a rotational rheometer, the recovery ability of the gel ink was measured through a plurality of cycles between continuous strain scanning and time scanning, and the viscosity of the gel ink was measured by changing a shear rate, where a frequency was 1 Hz and a strain was 0.53, as shown in Table 8.

TABLE 8

| Mass fraction | | | | | | | |
|---|---|---|---|---|---|---|---|
| (%) | 5 | 10 | 20 | 30 | 40 | 50 | 60 |
| Mechanical | 3.86055 ± 0.5 | 350 ± 497 | 696.187 ± 3.66705 | 2517.23 ± 176.4 | 5490.91 ± 400 | 26739.4 ± 5000 | 175035 ± 8027 |
| support | | | | | | | |
| strength (Pa) | | | | | | | |
| Viscosity | 2.14951 ± 0.05 | 109 ± 23 | 332.561 ± 6 | 975.25 ± 416 | 4834.97 ± 300 | 17700.3 ± 700 | 157935 ± 2000 |
| (Pa.s) | | | | | | | |
| Recovery | 96.4 | 95.3 | 96.7 | 98.8 | 86.7 | 72.4 | 61.2 |
| ability (%) | | | | | | | |

### Example 6

### (1) Preparing Negatively Charged Bioglass Particles

In this example, negatively charged bioglass particles were prepared by the sol-gel method. First, 300 mL of absolute ethanol was mixed with 20 mL of deionized water to obtain a mixture, the mixture was stirred at room temperature for 10 min, 17.5 mL of glacial acetic acid (25%) was added into the mixture and stirred evenly at 1500 rpm, and 38.7 mL of tetraethyl orthosilicate, 6.23 g of calcium nitrate and 1.97 mL of triethyl phosphate were in sequence added into the mixture, and the mixture was stirred at a rotational speed of 500 rpm for 12 h for reaction, after completion of the reaction, a resulting reactant was centrifuged and washed with deionized water to obtain negatively charged bioglass particles, which were dispersed in deionized water to prepare a particle suspension with a mass fraction of 10%. FIG. 6 shows that the bioglass particles were successfully synthesized, with a single particle size of 50 nm.

### (2) Preparing Positively Charged Bioglass Particles

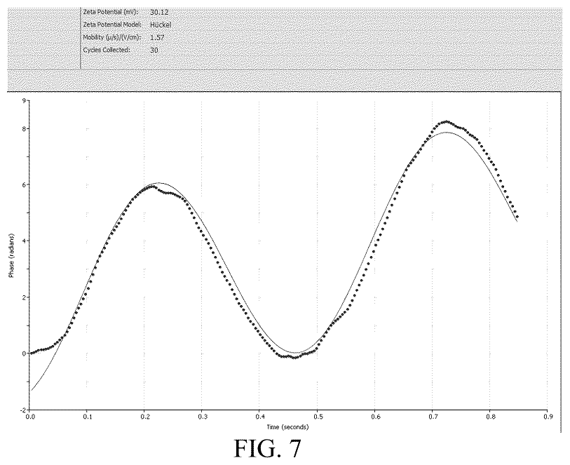

The bioglass particle suspension prepared in the step (1) was centrifuged to obtain precipitate at a lower layer, the precipitate at the lower layer was dispersed in butanol to prepare 400 mL of a disperse system with a concentration of 10 mg/mL, the disperse system was sonicated for 15 min, 4 mL of (3-Aminopropyl)trimethoxysilane was then added into the disperse system within 20 min by using a syringe pump, and the disperse system was reacted at room temperature for 8 h under stirring at a speed of 900 rpm. After completion of the reaction, a resulting reactant was centrifuged with deionized water to obtain positively charged bioglass particles, which were dispersed in the deionized water to prepare a particle suspension with a mass fraction of 10%. FIG. 7 shows that surface of the bioglass particles were successfully modified with positive charge, and the charge was +36 mv.

### (3) Preparing Gel Ink

The negatively charged bioglass particle suspension with the mass fraction of 10% obtained in the step (1) was added into the positively charged bioglass particle suspension with the mass fraction of 10% obtained in the step (2), a number ratio of the negatively charged bioglass particles to the positively charged bioglass particles in suspension was 1:1, and a precursor solution was obtained after the suspension was evenly stirred; phosphoric acid was added into the precursor solution, after being continuously stirred for 2 h, the solution was centrifuged at a speed of 8000 g for 25 min, supernatant fluid was then removed to obtain gel ink raw material with a solid phase content of 40 wt. %. Mechanical support strength of the gel ink was measured through the time scanning mode of a rotational rheometer, the recovery ability of the gel ink was measured through a plurality of cycles between continuous strain scanning and time scanning, and the viscosity of the gel ink was measured by changing a shear rate, where a frequency was 1 Hz and a strain was 0.5%, as shown in Table 1., as shown in Table 9.

TABLE 9

| | Mechanical | | Recovery |
|---|---|---|---|
| | support strength | Viscosity | ability |
| Gel ink | 97.1 kPa | 8638 Pa · s | 91.7% |

### (4) Printing a 3D Scaffold

CAD was used to draw a cube model with a length, width and height of 8 mm, the cube model was input to an extrusion printer, parameters of the extrusion printer were set as follows: the number of printing lines at each layer of 7, a printing speed of 3 mm/s and a height of the printing layer of 15 mm, and a needle with an inner diameter of 500 μm was used; the gel ink raw material prepared in the step (3) was loaded into a syringe of the printer to print out a cube model scaffold. The printing was performed layer by layer to finally form a target model green body.

### (5) Sintering the Model Scaffold

The cube model scaffold was put into a drying oven and dried at 40° C. for 12 h, the temperature was then raised up to 700° C. at a rate of 5° C./min, and then kept for 4 h to obtain a cured customized inorganic non-metallic scaffold. The cured 3D scaffold was subject to a compression test using a mechanical testing machine, and a compression rate was 1 mm/min, as shown in Table 10.

TABLE 10

| | Compressive | Modulus |
|---|---|---|
| | strength | of elasticity |
| 3D scaffold | 2.7 MPa | 4.3 MPa |

### Comparative Example 3 Pure Negatively Charged Bioglass Particle Ink

The negatively charged bioglass particle suspension prepared in the step (1) of Example 6 was prepared into a suspension with a mass fraction of 10%, acetic acid was then added into the suspension, after being continuously stirred for 2 h, the suspension was centrifuged at a speed of 8000 g for 25 min, supernatant fluid was then removed to obtain gel ink raw material with a solid phase content of 40 wt. %. Mechanical support strength of the gel ink was measured through the time scanning mode of a rotational rheometer, the recovery ability of the gel ink was measured through a plurality of cycles between continuous strain scanning and time scanning, and the viscosity of the gel ink was measured by changing a shear rate, where a frequency was 1 Hz and a strain was 0.5%, as shown in Table 11.

TABLE 11

| | Mechanical | | Recovery |
|---|---|---|---|
| | support strength | Viscosity | ability |
| Gel ink | 2030 kPa | 967 Pa · s | 78% |

### Comparative Example 4 Pure Positively Charged Bioglass Particle Ink

The positively charged bioglass particle suspension prepared in the step (2) of Example 6 was prepared into a suspension with a mass fraction of 10%, acetic acid was then added into the suspension, after being continuously stirred for 2 h, the suspension was centrifuged at a speed of 8000 g for 25 min, supernatant fluid was then removed to obtain gel ink raw material with a solid phase content of 40 wt. %. Mechanical support strength of the gel ink was measured through the time scanning mode of a rotational rheometer, the recovery ability of the gel ink was measured through a plurality of cycles between continuous strain scanning and time scanning, and the viscosity of the gel ink was measured by changing a shear rate, as shown in Table 12.

TABLE 12

| | Mechanical support strength | Viscosity | Recovery ability |
|---|---|---|---|
| Gel ink | 5437 Pa | 1717 Pa · s | 93% |

The non-monodisperse particles obtained in Example 6 and Comparative Examples 3 and 4 can still form gel ink with stronger mechanical properties through the mutual attraction of positive and negative charges. However, the gel ink formed by separate positively charged particles or negatively charged particles is just an accumulation of particles, which is not possible to balance the mechanical support strength and the recovery ability after damage.

### Example 7

### (1) Preparing Gel Ink

The negatively charged bioglass particle suspension with the mass fraction of 10% obtained in the step (1) of Example 6 was added into the positively charged bioglass particle suspension with the mass fraction of 10% obtained in the step (2) of Example 6, a number ratio of the negatively charged bioglass particles to the positively charged bioglass particles in suspension was 1:3, 1:1 and 3:1 respectively, and a precursor solution was obtained after the suspension was evenly stirred; acetic acid was added into the precursor solution, after being continuously stirred for 2 h, the solution was centrifuged at a speed of 6000 g for 20 min, supernatant fluid was then removed to obtain gel ink raw material with a solid phase content of 10 wt. %. Mechanical support strength of the gel ink was measured through the time scanning mode of a rotational rheometer, the recovery ability of the gel ink was measured through a plurality of cycles between continuous strain scanning and time scanning, and the viscosity of the gel ink was measured by changing a shear rate, where a frequency was 1 Hz and a strain was 0.5%, as shown in Table 13.

TABLE 13

| | Number ratios of the negatively charged | | |
|---|---|---|---|
| | bioglass particles to the positively | | |
| | charged bioglass particles | | |
| | 1:3 | 1:1 | 3:1 |
| Mechanical support | 679 ± 47 | 437 ± 5.8 | 231 ± 7 |
| strength (Pa) | | | |
| Viscosity (Pa · s) | 316 ± 2.4 | 343 ± 12 | 155 ± 0.8 |
| Recovery ability (%) | 92.5 | 92.2 | 90.6 |

### Example 8

### (1) Preparing Gel Bio-Ink

The negatively charged bioglass particle suspension with the mass fraction of 10% obtained in the step (1) of Example 6 was added into the positively charged bioglass particle suspension with the mass fraction of 10% obtained in the step (2) of Example 6, a number ratio of the negatively charged bioglass particles to the positively charged bioglass particles in suspension was 1:3, and a precursor solution was obtained after the suspension was evenly stirred; acetic acid was added into the precursor solution, after being continuously stirred for 2 h, the solution was centrifuged at a speed of 6000 g for 20 min, supernatant fluid was then removed to obtain gel ink raw material with a solid phase content of 10%, 20%, 30%, 40%, 50%, respectively. Mechanical support strength of the gel ink was measured through the time scanning mode of a rotational rheometer, the recovery ability of the gel ink was measured through a plurality of cycles between continuous strain scanning and time scanning, and the viscosity of the gel ink was measured by changing a shear rate, where a frequency was 1 Hz and a strain was 0.5%, as shown in Table 14.

TABLE 14

| | Mass fraction (%) | | | | |
|---|---|---|---|---|---|
| | 10 | 20 | 30 | 40 | 50 |
| Mechanical support | 679 ± 47 | 6382 ± 5473 | 53878 ± 13072 | 97148 ± 1020 | 123434 ± 4869 |
| strength (Pa) | | | | | |
| Viscosity (Pa · s) | 316 ± 2.4 | 4278 ± 148 | 24589 ± 4530 | 8638 ± 568 | 89637 ± 2851 |
| Recovery ability (%) | 92.5 | 94.3 | 92.6 | 91.7 | 87.9 |

### Example 9

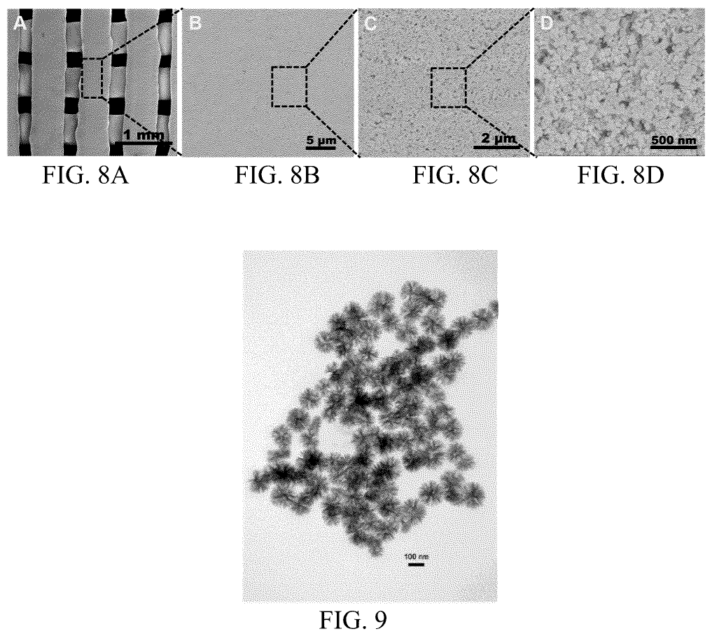

The gel bio-ink with a solid phase content of 30 wt. % prepared in Example 8 was used. Modeling software was utilized to build a 3D cube scaffold model of 15x 15x 15 mm, slicing software was used to slice the 3D cube scaffold model, and imported the sliced model into a 3D extrusion printer, a needle with an inner diameter of 600 μm was used, the obtained nanostructured bio-ink was then placed into a nozzle of the 3D printer to print out a cube model scaffold, and the printing was performed layer by layer to finally form a target model green body. The printed cube model scaffold was put into a drying oven and dried at 40° C. for 12 h, the temperature was then raised up to 700° C. at a rate of 5° C./min, and then kept for 4 h to obtain a cured customized inorganic non-metallic scaffold. FIGS. 8A to 8D show electron microscope scanning detection diagrams of a sintered bioglass scaffold. Specifically, FIG. 8A is an electron microscope image of the overall scaffold, FIG. 8B is a surface topography image of fibers of the scaffold, FIG. 8C is an enlarged view of the surface topography of FIG. 8B, and FIG. 8D is an enlarged view of the surface topography of FIG. 8C. It can be seen from FIG. 8A that the printed bioglass scaffold had a regular structure. It can be seen from FIG. 8B that the fibers of the scaffold were uniform and smooth, and the particles were evenly arranged. It can be seen from FIGS. 8C and 8D that the particles were tightly connected to form a uniform structure, and the surface had small holes of 0.1 μm. FIGS. 8A to 8D show that scaffold printed with the gel ink assembled from bioglass practices featured good printability, and the surface of the scaffold had uniform structure and pores.

### Example 10

### (1) Preparing Negatively Charged Mesoporous Bioglass Particles

In this example, mesoporous bioglass particles were prepared by a template method. First, 24.1 g of hexadecyl trimethyl ammonium bromide was dissolved in 1000 mL of deionized water to obtain a mixture, 3.2 mL of ammonia water (35%) was added into the mixture, the mixture was stirred at room temperature for 10 min, then 38.7 mL of tetraethyl orthosilicate, 6.23 g of calcium nitrate and 1.97 mL of triethyl phosphate were in sequence added into the mixture, and the mixture was stirred at a rotational speed of 500 rpm for 12 h for reaction. After completion of the reaction, a resulting reactant was centrifuged, dispersed and washed with ethanol (1 time), ethanol-water (1 time), water (4 times) for 6 times to obtain negatively charged mesoporous bioglass particles which were prepared into a particle suspension with a mass fraction of 10%. FIG. 9 is a transmission electron microscope image of mesoporous bioglass. It can be seen from FIG. 9 that a particle size of the mesoporous bioglass particle was about 100 nm, and individual particles were well dispersed.

### (2) Preparing Positively Charged Mesoporous Bioglass Particles

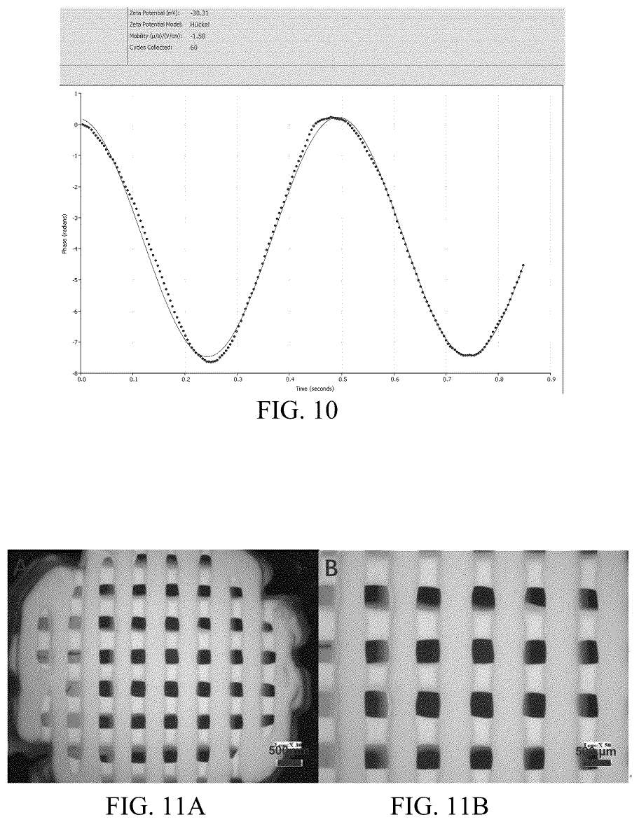

The mesoporous bioglass particle suspension prepared in the step (1) was centrifuged to obtain precipitate at a lower layer, the precipitate at the lower layer was dispersed in ethanol to prepare 400 mL of a disperse system with a concentration of 10 mg/mL, the disperse system was sonicated for 15 min and then was placed in a water bath at 40° C., 2 mM of cyclopropane-1-carboximidamide hydrochloride was then added into the disperse system within 20 min by using a syringe pump, and the disperse system was then reacted at 40° C. for 5 h under stirring at a speed of 1000 rpm. After completion of the reaction, a resulting reactant was washed three times with deionized water to obtain positively charged mesoporous bioglass particles which were prepared into a particle suspension with a mass fraction of 10%. FIG. 10 shows that surface of the mesoporous bioglass were successfully modified with positive charge, and the charge was +23 mv.

### (3) Preparing Gel Ink

The negatively charged mesoporous bioglass particle suspension with the mass fraction of 10% obtained in the step (1) was added into the positively charged mesoporous bioglass particle suspension with the mass fraction of 10% obtained in the step (2), a number ratio of the negatively charged mesoporous bioglass particles to the positively charged bioglass particles in suspension was 1:3, and a precursor solution was obtained after the suspension was evenly stirred; acetic acid was added into the precursor solution, after being continuously stirred for 2 h, the solution was centrifuged at a speed of 9000 g for 15 min, supernatant fluid was then removed to obtain gel ink raw material with a solid phase content of 30 wt. %. Mechanical support strength of the gel ink was measured through the time scanning mode of a rotational rheometer, the recovery ability of the gel ink was measured through a plurality of cycles between continuous strain scanning and time scanning, and the viscosity of the gel ink was measured by changing a shear rate, where a frequency was 1 Hz and a strain was 0.5%, as shown in Table 15.

TABLE 15

| | Mechanical support strength | Viscosity | Recovery ability |
|---|---|---|---|
| Gel ink | 89437 Pa | 8914 Pa · s | 90% |

### (4) Printing a 3D Scaffold

CAD was used to draw a cube model with a length, width and height of 12 mm, the cube model was input to an extrusion printer, parameters of the extrusion printer were set as follows: the number of printing lines at each layer of 9, a printing speed of 4 mm/s and a height of the printing layer of 5 mm, and a needle with an inner diameter of 600 μm was used; the gel ink raw material prepared in the step (3) was loaded into a syringe of the printer to print out a cube model scaffold. The printing was performed layer by layer to finally form a target model green body.

### (5) Sintering the Model Scaffold

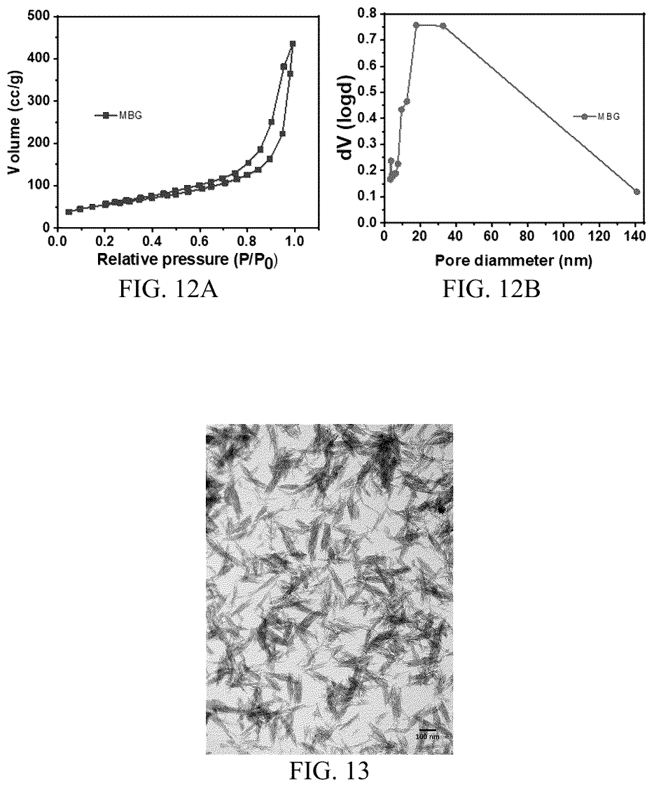

The cube model scaffold was put into a sintering furnace and dried at 40° C. for 12 h, the temperature was then raised up to 800° C. at a rate of 5° C./min, and then kept for 4 h to obtain a cured customized inorganic non-metallic scaffold, which is a mesoporous scaffold having penetrating macroscopic pores and microscopic pores. FIG. 11A and FIG. 11B show a characterization diagram of a sintered cube scaffold. It can be seen from FIGS. 11A and 11B that a pore size of the printed scaffold was 250 μm. FIG. 12A is a nitrogen adsorption-desorption curve of the mesoporous scaffold after sintering, with a pore volume of 0.417 cc/g and a specific surface area of 86.59 m²/g; and FIG. 12B is a distribution curve of mesoporous sizes of the scaffold, with a microscopic pore diameter of the scaffold of 17.939 nm. The sintered 3D scaffold was subject to a compression test using a mechanical testing machine, and a compression rate was 1 mm/min, as shown in Table 16.

TABLE 16

| | Compressive strength | Modulus of elasticity |
|---|---|---|
| 3 D scaffold | 1.5 MPa | 2.3 MPa |

### Comparative Example 5 Pure Negatively Charged Mesoporous Bioglass Particle Scaffold

The negatively charged mesoporous bioglass particles prepared in the step (1) of Example 10 were prepared into a suspension with a mass fraction of 10%, acetic acid was then added into the suspension, the suspension was stirred continuously for 2 h and then centrifuged at a speed of 9000 g for 15 min, supernatant fluid was then removed to obtain gel ink raw material with a solid phase content of 30 wt. %. Mechanical support strength of the gel ink was measured through the time scanning mode of a rotational rheometer, the recovery ability of the gel ink was measured through a plurality of cycles between continuous strain scanning and time scanning, and the viscosity of the gel ink was measured by changing a shear rate, where a frequency was 1 Hz and a strain was 0.5%, as shown in Table 17.

TABLE 17

| | Mechanical support strength | Viscosity | Recovery ability |
|---|---|---|---|
| Gel ink | 1014 Pa | 467 Pa · s | 80% |

### Comparative Example 6 Pure Positively Charged Mesoporous Bioglass Particle Scaffold

The negatively charged mesoporous bioglass particles prepared in the step (2) of Example 10 were prepared into a suspension with a mass fraction of 10%, acetic acid was then added into the suspension, the suspension was stirred continuously for 2 h and then centrifuged at a speed of 9000 g for 15 min, supernatant fluid was then removed to obtain gel ink raw material with a solid phase content of 30 wt. %. Mechanical support strength of the gel ink was measured through the time scanning mode of a rotational rheometer, the recovery ability of the gel ink was measured through a plurality of cycles between continuous strain scanning and time scanning, and the viscosity of the gel ink was measured by changing a shear rate, as shown in Table 18.

TABLE 18

| | Mechanical support strength | Viscosity | Recovery ability |
|---|---|---|---|
| Gel ink | 3417 Pa | 1778 Pa · s | 82% |

The monodisperse mesoporous particles obtained in Example 9 and Comparative Examples 5 and 6 can still form gel ink with stronger mechanical properties through the mutual attraction of positive and negative charges, proving that the preparation method of gel ink formed by the mutual attraction of particles is universal and applicable.

### Example 11

### (1) Preparing Mesoporous Bioglass Gel Ink

The negatively charged mesoporous bioglass particle suspension with the mass fraction of 10% obtained in the step (1) of Example 10 was added into the positively charged mesoporous bioglass particle suspension with the mass fraction of 10% obtained in the step (2) of Example 10, a number ratio of the negatively charged particles to the positively charged particles in suspension was 1:3, 1:1 and 3:1 respectively, and a precursor solution was obtained after the suspension was evenly stirred; acetic acid was added into the precursor solution, after being continuously stirred for 2 h, the solution was centrifuged at a speed of 5000 g for 10 min, supernatant fluid was then removed to obtain gel ink raw material with a solid phase content of 10 wt. %. Mechanical support strength of the gel ink was measured through the time scanning mode of a rotational rheometer, the recovery ability of the gel ink was measured through a plurality of cycles between continuous strain scanning and time scanning, and the viscosity of the gel ink was measured by changing a shear rate, where a frequency was 1 Hz and a strain was 0.5%, as shown in Table 19.

TABLE 19

| | Number ratios of the negatively charged | | |
|---|---|---|---|
| | mesoporous bioglass particles to the positively | | |
| | charged mesoporous bioglass particles | | |
| | 1:3 | 1:1 | 3:1 |
| Mechanical support | 637 ± 5.8 | 279 ± 47 | 131 ± 7 |
| strength (Pa) | | | |
| Viscosity (Pa · s) | 316 ± 2.4 | 143 ± 12 | 95 ± 0.8 |
| Recovery ability | 93.7 | 87.5 | 83.9 |

### Example 12

### (1) Preparing Nanostructured Bio-Ink

The negatively charged mesoporous bioglass particle suspension with the mass fraction of 10% obtained in the step (1) of Example 10 was added into the positively charged mesoporous bioglass particle suspension with the mass fraction of 10% obtained in the step (2) of Example 10, a number ratio of the negatively charged particles to the positively charged particles in suspension was 1:3, and a precursor solution was obtained after the suspension was evenly stirred; acetic acid was added into the precursor solution, after being continuously stirred for 2 h, the solution was centrifuged at a speed of 5000 g for 10 min, supernatant fluid was then removed to obtain gel ink raw material with a solid phase content of 10%, 20%, 30%, 40% and 50% respectively. Mechanical support strength of the ink was measured through the time scanning mode of a rotational rheometer, the recovery ability of the ink was measured through a plurality of cycles between continuous strain scanning and time scanning, and the viscosity of the ink was measured by changing a shear rate, where a frequency was 1 Hz and a strain was 0.5%, as shown in Table 20.

TABLE 20

| | Mass fraction (%) | | | | |
|---|---|---|---|---|---|
| | 10 | 20 | 30 | 40 | 50 |
| Mechanical support | 637 ± 5.8 | 4382 ± 5473 | 53878 ± 3072 | 113748 ± 10200 | 423434 ± 23869 |
| strength (Pa) | | | | | |
| Viscosity (Pa · s) | 316 ± 2.4 | 1578 ± 545 | 24586 ± 1789 | 96387 ± 5478 | 225838 ± 14558 |
| Recovery ability | 93.7 | 91.5 | 86.7 | 85.6 | 75.3 |

### Example 13

### (1) Preparing Positively Charged Calcium Phosphate Particles

Calcium phosphate particles were prepared by a chemical precipitation method. 100 mL of H₃PO₄ solution (75 mM) was added dropwise into a 100 mL of aqueous suspension containing Ca(OH)₂ (125 mM) to obtain a mixture, pH of the mixture was adjusted to be 7.0, and the mixture was stirred continuously at room temperature for 14-16 h for reaction, a resulting calcium phosphate nanoparticles were centrifuged and then washed three times with deionized water to obtain calcium phosphate nanoparticles. A transmission electron microscope image of the calcium phosphate nanoparticles is shown in FIG. 13, and it can be seen that the calcium phosphate nanoparticles were evenly dispersed and had a single particle size.

### (2) Preparing Negatively Charged Calcium Phosphate Particles

Sodium citrate was adsorbed on surface of calcium phosphate particles to make the surface negatively charged. The calcium phosphate particles prepared in the step (1) were dispersed, at a concentration of 10 mg/mL, in 10 mM of sodium citrate aqueous solution and stirred for 14-16 h for reaction, and resulting particles were then centrifuged and washed three times with deionized water to obtain the negatively charged calcium phosphate particles. A Zeta potential meter was used to test a surface potential of the particles synthesized in the steps (1) and (2) under the condition of pH=7, and the results were shown in Table 21.

TABLE 21

| | Positively | Negatively |
|---|---|---|
| | charged calcium | charged calcium |
| | phosphate particles | phosphate particles |
| Surface potential | 3.0 ± 0.3 | −20.1 ± 0.6 |

### (3) Preparing Gel Ink

A suspension with a mass fraction of 10% prepared with the negatively charged calcium phosphate particles obtained in the step (2) was added into a suspension with a mass fraction of 10% prepared with the positively charged calcium phosphate particles obtained in the step (1), a number ratio of the negatively charged calcium phosphate particles to the positively charged calcium phosphate particles in suspension was 1:3, 1:2, 1:1, 5:1 and 10:1, respectively, and a precursor solution was obtained after the suspension was evenly stirred; acetic acid was added into the precursor solution, after being continuously stirred for 2 h, the solution was centrifuged at a speed of 5000 g for 10 min, supernatant fluid was then removed to obtain gel ink raw material with a solid phase content of 10 wt. %. Mechanical support strength of the gel ink was measured through the time scanning mode of a rotational rheometer, the recovery ability of the gel ink was measured through a plurality of cycles between continuous strain scanning and time scanning, and the viscosity of the gel ink was measured by changing a shear rate, where a frequency was 1 Hz and a strain was 0.5%, as shown in Table 22.

TABLE 22

| | Number ratios of the | | | | |
|---|---|---|---|---|---|
| | negatively charged calcium | | | | |
| | phosphate particles to the | | | | |
| | positively charged calcium | | | | |
| | phosphate particles | | | | |
| | 1:3 | 1:2 | 1:1 | 5:1 | 10:1 |
| Mechanical support | 122 ± 23 | 318 ± 13 | 109 ± 34 | 13.5 ± 5 | 0.02 ± 0.01 |
| strength (Pa) | | | | | |
| Viscosity (Pa · s) | 20 ± 10.5 | 22.6 ± 7 | 14.7 ± 3 | 0.3 ± 0.2 | 0.023 ± 0.007 |
| Recovery ability (%) | 97.9 | 96.7 | 92 | 89.4 | 87.9 |

### Example 14

### (1) Preparing Nanostructured Bio-Ink

A suspension with a mass fraction of 10% prepared with the negatively charged calcium phosphate particles obtained in the step (2) of Example 13 was added into a suspension with a mass fraction of 10% prepared with the positively charged calcium phosphate particles obtained in the step (1) of Example 13, a number ratio of the negatively charged calcium phosphate particles to the positively charged calcium phosphate particles in suspension was 1:3, and a precursor solution was obtained after the suspension was evenly stirred; nitric acid was added into the precursor solution, after being continuously stirred for 2 h, the solution was centrifuged at a speed of 10000 g for 10 min, supernatant fluid was then removed to obtain gel ink raw material with a solid phase content of 10%, 20%, 30%, 40% and 50% respectively. Mechanical support strength of the ink was measured through the time scanning mode of a rotational rheometer, the recovery ability of the ink was measured through a plurality of cycles between continuous strain scanning and time scanning, and the viscosity of the ink was measured by changing a shear rate, where a frequency was 1 Hz and a strain was 0.5%, as shown in Table 23.

TABLE 23

| | Mass fraction (%) | | | | |
|---|---|---|---|---|---|
| | 10 | 20 | 30 | 40 | 50 |
| Mechanical support | 122 ± 23 | 1781 ± 125 | 5234 ± 1256 | 19103 ± 3513 | 73691 ± 13479 |
| strength (Pa) | | | | | |
| Viscosity (Pa · s) | 20 ± 10.5 | 851 ± 121 | 4752 ± 1561 | 12889 ± 8153 | 54576 ± 13612 |
| Recovery ability | 97.9 | 94.7 | 86.8 | 86.7 | 84.9 |

### Example 15

### (1) Preparing Negatively Charged Alumina Particles

In this example, alumina particles were prepared by a hydrothermal method. First, 0.16 mol/L of Al(NO₃)₃·9H₂O was dissolved in 100 mL of deionized water to obtain a mixture, hydrazine hydrate solution was dropped dropwise at a rate of 0.5 mL/min into the mixture with a constant pressure funnel under stirring at 500 rpm until the pH of the mixture reached 5.0, the mixture was reacted for 3 h, and the reacted solution was then transferred to a reaction kettle and reacted at 200° C. for 12 h. After cooling down to room temperature, a resulting reactant was washed three times with a mixture of deionized water and absolute ethanol to obtain negatively charged alumina particles which were dispersed in deionized water to prepare a particle suspension with a mass fraction of 10%.

### (2) Preparing Positively Charged Alumina Particles

The negatively charged alumina particle suspension prepared in the step (1) was centrifuged to obtain precipitate at a lower layer, the precipitate at the lower layer was dispersed in ethanol to prepare 400 mL of a disperse system with a concentration of 10 mg/mL, the disperse system was sonicated for 15 min and then placed in a water bath at 40° C., 2 mL of (3-Aminopropyl)trimethoxysilane was then added into the disperse system within 20 min by using a syringe pump, and the disperse system was then reacted at 40° C. for 5 h under stirring at a speed of 1000 rpm. After completion of the reaction, a resulting reactant was washed three times with deionized water to obtain positively charged alumina particles which were prepared into a particle suspension with a mass fraction of 10%.

### (3) Preparing Gel Ink

The negatively charged alumina particle suspension with the mass fraction of 10% obtained in the step (1) was added into the positively charged alumina particle suspension with the mass fraction of 10% obtained in the step (2), a number ratio of the negatively charged alumina particles to the positively charged alumina particles in suspension was 1:3, and a precursor solution was obtained after the suspension was evenly stirred; acetic acid was added into the precursor solution, after being continuously stirred for 2 h, the solution was centrifuged at a speed of 4000 g for 25 min, supernatant fluid was then removed to obtain gel ink raw material with a solid phase content of 30%. Mechanical support strength of the gel ink was measured through the time scanning mode of a rotational rheometer, the recovery ability of the gel ink was measured through a plurality of cycles between continuous strain scanning and time scanning, and the viscosity of the gel ink was measured by changing a shear rate, where a frequency was 1 Hz and a strain was 0.5%, as shown in Table 24.

TABLE 24

| | Mechanical support strength | Viscosity | Recovery ability |
|---|---|---|---|
| Gel ink | 19477 Pa | 5919 Pa · s | 80% |

### (4) Printing a 3D Scaffold

CAD was used to draw a cube model with a length, width and height of 12 mm, the cube model was input to an extrusion printer, parameters of the extrusion printer were set as follows: the number of printing lines at each layer of 9, a printing speed of 4 mm/s and a height of the printing layer of 5 mm, and a needle with an inner diameter of 600 μm was used; the gel ink raw material prepared in the step (3) was loaded into a syringe of the printer to print out a cube model scaffold. The printing was performed layer by layer to finally form a target model green body.

### (5) Sintering the Model Scaffold:

The cube model scaffold was put into a drying oven and dried at 40° C. for 12 h, the temperature was then raised up to 1500° C. at a rate of 5° C./min, and then kept for 4 h to obtain a cured customized inorganic non-metallic scaffold. The cured 3D scaffold was subject to a compression test using a mechanical testing machine, and a compression rate was 1 mm/min, as shown in Table 25.

TABLE 25

| | Compressive strength | Modulus of elasticity |
|---|---|---|
| 3D scaffold | 11.5 MPa | 15.2 MPa |

### Example 16

### (1) Preparing Hydrophobic Silicon Dioxide Particles

In this example, hydrophobic silicon dioxide particles were prepared by modifying the negatively charged silicon dioxide particles with a particle size of 50 nm prepared in Example 1. The particle suspension of silicon dioxide with a particle size of 50 nm was centrifuged to obtain precipitate at a lower layer, the precipitate at the lower layer was dispersed in absolute ethanol to prepare 400 mL of a disperse system with a concentration of 20 mg/mL, the disperse system was stirred for 30 min, 4 mL of octadecyltrimethoxysilane was then added into the disperse system within 20 min by using a syringe pump, and the disperse system was then stirred at a speed of 600 rpm and reacted at room temperature for 8 h. After completion of the reaction, a resulting reactant was washed with absolute ethanol to obtain hydrophobic silicon dioxide particles.

### (2) Preparing Gel Ink

The hydrophobic silicon dioxide particles obtained in the step (1) were dispersed in deionized water, and then centrifuged at a speed of 8000 g for 15 min, supernatant fluid was then removed to obtain gel ink raw material with a solid phase content of 30 wt. %. Mechanical support strength of the gel ink was measured through the time scanning mode of a rotational rheometer, the recovery ability of the gel ink was measured through a plurality of cycles between continuous strain scanning and time scanning, and the viscosity of the gel ink was measured by changing a shear rate, where a frequency was 1 Hz and a strain was 0.5%, as shown in Table 26.

TABLE 26

| | Mechanical support strength | Viscosity | Recovery ability |
|---|---|---|---|
| Gel ink | 89.7 kPa | 8000 Pa · s | 83% |

### Example 17

### (1) Preparing Hydrophobic Silicon Dioxide Particles

In this example, hydrophobic silicon dioxide particles were prepared by modifying the positively charged silicon dioxide particles with a particle size of 50 nm prepared in Example 1. The particle suspension of silicon dioxide with a particle size of 50 nm was centrifuged to obtain precipitate at a lower layer, the precipitate at the lower layer was dispersed in acetone to prepare 400 mL of a disperse system with a concentration of 20 mg/mL, the disperse system was stirred for 30 min, 4 mL of octadecanoic acid was then added into the disperse system within 20 min by using a syringe pump, and the disperse system was then stirred at a speed of 600 rpm and reacted at room temperature for 8 h. After completion of the reaction, a resulting reactant was washed with absolute ethanol to obtain the hydrophobic silicon dioxide particles.

### (2) Preparing Gel Ink

The hydrophobic silicon dioxide particles obtained in the step (1) were dispersed in deionized water, and then centrifuged at a speed of 8000 g for 15 min, supernatant fluid was then removed to obtain gel ink raw material with a solid phase content of 30 wt. %. Mechanical support strength of the gel ink was measured through the time scanning mode of a rotational rheometer, the recovery ability of the gel ink was measured through a plurality of cycles between continuous strain scanning and time scanning, and the viscosity of the gel ink was measured by changing a shear rate, where a frequency was 1 Hz and a strain was 0.5%, as shown in Table 27.

TABLE 27

| | Mechanical | | |
|---|---|---|---|
| | support | | Recovery |
| | strength | Viscosity | ability |
| Gel ink | 85.3 kPa | 7859 Pa · s | 85% |

### Example 18

### (1) Preparing Hydrophobic Silicon Dioxide Particles

In this example, hydrophobic silicon dioxide particles were prepared by modifying the positively charged silicon dioxide particles with a particle size of 50 nm prepared in Example 1. The particle suspension of silicon dioxide with a particle size of 50 nm was centrifuged to obtain precipitate at a lower layer, the precipitate at the lower layer was dispersed in acetone to prepare 400 mL of a disperse system with a concentration of 20 mg/mL, the disperse system was stirred for 30 min, 4 mL of perfluorooctyltriethoxysilane was then added into the disperse system within 20 min by using a syringe pump, and the disperse system was then stirred at a speed of 600 rpm and reacted at room temperature for 8 h. After completion of the reaction, a resulting reactant was washed with absolute ethanol to obtain the hydrophobic silicon dioxide particles.

### (2) Preparing Gel Ink

The hydrophobic silicon dioxide particles obtained in the step (1) were dispersed in deionized water, and then centrifuged at a speed of 8000 g for 15 min, supernatant fluid was then removed to obtain gel ink raw material with a solid phase content of 30 wt. %. Mechanical support strength of the gel ink was measured through the time scanning mode of a rotational rheometer, the recovery ability of the gel ink was measured through a plurality of cycles between continuous strain scanning and time scanning, and the viscosity of the gel ink was measured by changing a shear rate, where a frequency was 1 Hz and a strain was 0.5%, as shown in Table 28.

TABLE 28

| | Mechanical | | |
|---|---|---|---|
| | support | | Recovery |
| | strength | Viscosity | ability |
| Gel ink | 90.3 kPa | 8573 Pa · s | 75% |

### Example 19

### (1) Preparing Hydrophobic Silicon Dioxide Particles

In this example, hydrophobic silicon dioxide particles were prepared by modifying the negatively charged silicon dioxide particles with a particle size of 50 nm prepared in Example 1. The particle suspension of silicon dioxide with a particle size of 50 nm was centrifuged to obtain precipitate at a lower layer, the precipitate at the lower layer was dispersed in deionized water to prepare 400 mL of a disperse system with a concentration of 20 mg/mL, the disperse system was stirred for 30 min, 4 mL of trimethylchlorosilane was then added into the disperse system within 20 min by using a syringe pump, and the disperse system was then stirred at a speed of 600 rpm and reacted at room temperature for 8 h. After completion of the reaction, a resulting reactant was washed with absolute ethanol to obtain the hydrophobic silicon dioxide particles.

### (2) Preparing Gel Ink

The hydrophobic silicon dioxide particles obtained in the step (1) were dispersed in deionized water, and then centrifuged at a speed of 8000 g for 15 min, supernatant fluid was then removed to obtain gel ink raw material with a solid phase content of 30 wt. %. Mechanical support strength of the gel ink was measured through the time scanning mode of a rotational rheometer, the recovery ability of the gel ink was measured through a plurality of cycles between continuous strain scanning and time scanning, and the viscosity of the gel ink was measured by changing a shear rate, where a frequency was 1 Hz and a strain was 0.5%, as shown in Table 29:

TABLE 29

| | Mechanical | | |
|---|---|---|---|
| | support | | Recovery |
| | strength | Viscosity | ability |
| Gel ink | 80 kPa | 7523 Pa · s | 86% |

### (3) Printing a 3D Scaffold

CAD was used to draw a cube model with a length, width and height of 15 mm, the cube model was input to an extrusion printer, parameters of the extrusion printer were set as follows: the number of printing lines at each layer of 15, a printing speed of 3 mm/s and a height of the printing layer of 15 mm, and a needle with an inner diameter of 500 μm was used; the gel ink raw material prepared in the step (3) was loaded into a syringe of the printer to print out a cube model scaffold. The printing was performed layer by layer to finally form a target model green body.

### (4) Performing Heat Treatment of the Model Scaffold

The cube model scaffold was put into a sintering furnace and dried at 40° C. for 12 h, the temperature was then raised up to 700° C. at a rate of 5° C./min, and then kept for 4 h to obtain a cured customized inorganic non-metallic scaffold. The cured 3D scaffold was subject to a compression test using a mechanical testing machine, and a compression rate was 1 mm/min, as shown in Table 30.

TABLE 30

| | Compressive | Modulus of |
|---|---|---|
| | strength | elasticity |
| 3D scaffold | 11.5 MPa | 13.8 MPa |

### Example 20

### (1) Preparing Ferroferric Oxide Particles

In this example, ferroferric oxide particles were prepared by a coprecipitation method. 50 mL of deionized water was added to a round bottom flask, and then a condenser, a nitrogen pipe and a thermometer were connected. Oxygen in the deionized water was purified with the nitrogen for about 10 min, then 0.52 mmol of FeSO₄·6H₂O (0.7 g) and 1.08 mmol of FeCl₃·6H₂O (0.145 g) were ultrasonically dissolved in 2 mL of hydrochloric acid to obtain a mixture, then the mixture was added into the deionized water when the deionized water's temperature reached 100° C., and 5 min later, 30 mL of ammonia water (25%) was quickly added and stirred at 600 rpm to react. After 2 h of condensation and reflux reaction, the ferroferric oxide particles were collected by a centrifugal separation method, and after centrifugal washing, the ferroferric oxide particles were dispersed in deionized water to prepare a particle suspension with a mass fraction of 30%.

### (2) Preparing Gel Ink

Under the action of a magnetic field of 150 A/m, magnetic particles in the ferroferric oxide particle suspension obtained in the step (1) was assembled to form a uniform network structure, the assembled suspension was then centrifuged at a speed of 8000 g for 25 min, supernatant fluid was then removed to obtain raw material of gel ink, and the raw material contained a solid phase content of 40 wt. %. Mechanical support strength of the gel ink was measured through the time scanning mode of a rotational rheometer, the recovery ability of the gel ink was measured through a plurality of cycles between continuous strain scanning and time scanning, and the viscosity of the gel ink was measured by changing a shear rate, where a frequency was 1 Hz and a strain was 0.5%, as shown in Table 31.

TABLE 31

| | Mechanical | | |
|---|---|---|---|
| | support | | Recovery |
| | strength | Viscosity | ability |
| Gel ink | 109.7 kPa | 1013 Pa · s | 92% |

### (3) Printing a 3D Scaffold

CAD was used to draw a cube model with a length, width and height of 15 mm, the cube model was input to an extrusion printer, parameters of the extrusion printer were set as follows: the number of printing lines at each layer of 15, a printing speed of 3 mm/s and a height of the printing layer of 15 mm, and a needle with an inner diameter of 500 μm was used; the gel ink raw material prepared in the step (3) was loaded into a syringe of the printer to print out a cube model scaffold. The printing was performed layer by layer to finally form a target model green body.

### (4) Performing Heat Treatment of the Model Scaffold

The cube model scaffold was put into a sintering furnace and dried at 40° C. for 12 h, the temperature was then raised up to 700° C. at a rate of 5° C./min, and then kept for 4 h to obtain a cured customized inorganic non-metallic scaffold. The cured 3D scaffold was subject to a compression test using a mechanical testing machine, and a compression rate was 1 mm/min, as shown in Table 32.

TABLE 32

| | Compressive | Modulus of |
|---|---|---|
| | strength | elasticity |
| 3D scaffold | 13.2 MPa | 17.3 MPa |

### Example 21

### (1) Preparing Negatively Charged Barium Titanate Particles

6.8 g of hexadecyl trimethyl ammonium bromide surfactant was weighed and dissolved in 100 mL of deionized water to obtain a first mixture, after being stirred at 600 rpm for 1 h, 9.45 g of TiCl₄ solution was added in the first mixture in an ice-water bath environment to obtain a second mixture, after being stirred for 30 min, 21.2 g of BaCl₂·2H₂O added into the second mixture to obtain a third mixture, after being stirred at 600 rpm for 1 h, a temperature of the third mixture was gradually raised up to 35° C., and pH of the third mixture was then adjusted to 7.2, and the synthesis reaction was completed after magnetic stirring for 10 h at 600 rpm in a water bath at 35° C. After completion of the reaction, a resulting solution was washed with deionized water and centrifuged at 8000 rpm for three times to obtain negatively charged barium titanate particles which were dispersed in deionized water and sonicated for 10 min to prepare a barium titanate particle suspension with a mass fraction of 5%.

### (2) Preparing Positively Charged Barium Titanate Particles

The negatively charged barium titanate particle suspension prepared in the step (1) was centrifuged to obtain precipitate at a lower layer, the precipitate was dispersed in ethanol to prepare 400 mL of a disperse system with a concentration of 10 mg/mL, disperse system was sonicated for 15 min and then placed in a water bath at 40° C., 2 mM of cyclopropane-1-carboximidamide hydrochloride was then added into the disperse system within 20 min by using a syringe pump, and the disperse system was then stirred at a speed of 1000 rpm and reacted at 40° C. for 5 h. After completion of the reaction, a resulting reactant were washed three times with deionized water to obtain positively charged barium titanate particles which were prepared into a particle suspension with a mass fraction of 5%.

### (3) Preparing Gel Ink

The negatively charged barium titanate particle suspension with a mass fraction of 5% obtained in the step (1) was added into the positively charged barium titanate particle suspension with a mass fraction of 5% obtained in the step (2), a number ratio of the negatively charged barium titanate particles to the positively charged barium titanate particles in suspension was 1:3, and a precursor solution was obtained after the suspension was evenly stirred; phosphoric acid was added into the precursor solution, after being continuously stirred for 2 h, the solution was centrifuged at a speed of 7000 g for 20 min, supernatant fluid was then removed to obtain gel ink raw material with a solid phase content of 35%. Mechanical support strength of the gel ink was measured through the time scanning mode of a rotational rheometer, the recovery ability of the gel ink was measured through a plurality of cycles between continuous strain scanning and time scanning, and the viscosity of the gel ink was measured by changing a shear rate, where a frequency was 1 Hz and a strain was 0.5%, as shown in Table 33.

TABLE 33

| | Mechanical | | |
|---|---|---|---|
| | support | | Recovery |
| | strength | Viscosity | ability |
| Gel ink | 9836 Pa | 6385 Pa · s | 85% |

### (4) Printing a 3D Scaffold

CAD was used to draw a cube model with a length, width and height of 15 mm, the cube model was input to an extrusion printer, parameters of the extrusion printer were set as follows: the number of printing lines at each layer of 9, a printing speed of 4 mm/s and a height of the printing layer of 5 mm, and a needle with an inner diameter of 600 μm was used; the gel ink raw material prepared in the step (3) was loaded into a syringe of the printer to print out a cube model scaffold. The printing was performed layer by layer to finally form a target model green body.

### (5) Sintering the Model Scaffold

The cube model scaffold was put into a drying oven and dried at 40° C. for 12 h, the temperature was then raised up to 1200° C. at a rate of 5° C./min, and then kept for 4 h to obtain a cured customized barium titanate ceramic scaffold. In order to characterize piezoelectric and dielectric properties of the scaffold, the barium titanate scaffold was polarized by applying a DC voltage of 1 kV/mm at 120° C. for 30 min. A piezoelectric constant tester was used to test a piezoelectric constant, and an impedance analyzer was used to measure a dielectric constant. The results are shown in Table 34.

TABLE 34

| | Piezoelectric | Dielectric |
|---|---|---|
| | constant | constant |
| Barium titanate scaffold | 404 Pc/N | 3740 kHz |

### Comparative Example 7 Preparing Pure Negatively Charged Barium Titanate Particle Gel Ink

(1) The negatively charged barium titanate particles prepared in the step (1) of Example 21 were prepared into a suspension with a mass fraction of 5%, phosphoric acid was then added into the suspension, the suspension was continuously stirred for 2 h and then centrifuged at a speed of 7000 g for 20 min, supernatant fluid was then removed to obtain gel ink raw material with a solid phase content of 35 wt %. Mechanical support strength of the gel ink was measured through the time scanning mode of a rotational rheometer, the recovery ability of the gel ink was measured through a plurality of cycles between continuous strain scanning and time scanning, and the viscosity of the gel ink was measured by changing a shear rate, as shown in Table 35.

TABLE 35

| | Mechanical | | |
|---|---|---|---|
| | support | | Recovery |
| | strength | Viscosity | ability |
| Gel ink | 4562 Pa | 3571 Pa · s | 83% |

### (2) Printing a 3D Scaffold

CAD was used to draw a circuit line model, the model was input to an extrusion printer, parameters of the printer were set as follows: the number of printing lines at each layer of 5, a printing speed of 4 mm/s and a height of the printing layer of 1 mm, and a needle with an inner diameter of 400 μm was used; the gel ink raw material prepared in the step (1) was loaded into a syringe of the printer to print out a model scaffold. The printing was performed layer by layer to finally form a target model green body.

### (3) Sintering the Model Scaffold

The barium titanate scaffold was put into a drying oven and dried at 40° C. for 12 h, the temperature was then raised up to 1200° C. at a rate of 5° C./min, and then kept for 4 h to obtain a cured barium titanate ceramic scaffold. In order to characterize piezoelectric and dielectric properties of the scaffold, the barium titanate scaffold was polarized by applying a DC voltage of 1 kV/mm at 120° C. for 30 min. A piezoelectric constant tester was used to test a piezoelectric constant, and an impedance analyzer was used to measure a dielectric constant. The results are shown in Table 36.

TABLE 36

| | Piezoelectric | Dielectric |
|---|---|---|
| | constant | constant |
| Barium titanate scaffold | 360 Pc/N | 2320 kHz |

It can be seen from Example 21 and Comparative Example 7 that the gel ink obtained by regulating the assembly of negatively charged barium titanate particles and positively charged barium titanate particles had stronger mechanical strength and greater viscosity, and also had better piezoelectric effects, thereby having better application prospect as a piezoelectric sensor.

### Example 22

(1) Preparing Negatively Charged Ti₃C₂Tx MXene Nanosheets

In this example, 1 g of lithium fluoride was dissolved in 20 mL of concentrated hydrochloric acid solution to obtain a mixed solution and placed in a 250 mL Teflon beaker, 1 g of Ti₃AlC₂ was then added into the mixed solution, after being subject to magnetic stirring at 35° C. for 24 h, the mixed solution was then centrifuged and washed at 3500 rpm for three times until the pH of supernatant was 6, and a resulting centrifugal substance was dispersed in deionized water and sonicated for 10 min to prepare a MXene nanosheet dispersion with a concentration of 1 mg/mL.

(2) Preparing Positively Charged Ti₃C₂Tx MXene Nanosheets

A poly dimethyl diallyl ammonium chloride solution (10 mL, 1 wt. %) was added dropwise into the MXene nanosheet dispersion (100 mL, 1 mg/mL) obtained in the step (1) to obtain a mixed solution, after being subject to magnetic stirring for 24 h, the mixed solution was centrifuged at 4000 rpm for 1 h, a resulting precipitate was then washed twice with deionized water, and then sonicated for 5 min to obtain a positively charged MXene nanosheet dispersion with a concentration of 1 mg/mL.

### (3) Preparing Gel Ink

The negatively charged negatively charged MXene nanosheet dispersion with a mass fraction of 0.1% obtained in the step (1) was added into the positively charged MXene nanosheet dispersion with a mass fraction of 0.1% obtained in the step (2), a number ratio of the negatively charged alumina particles to the positively charged alumina particles in suspension was 1:3, and a precursor solution was obtained after the suspension was evenly stirred; acetic acid was added into the precursor solution, after being continuously stirred for 2 h, the solution was centrifuged at a speed of 10000 g for 60 min, supernatant fluid was then removed to obtain gel ink raw material with a solid phase content of 15%. Mechanical support strength of the gel ink was measured through the time scanning mode of a rotational rheometer, the recovery ability of the gel ink was measured through a plurality of cycles between continuous strain scanning and time scanning, and the viscosity of the gel ink was measured by changing a shear rate, where a frequency was 1 Hz and a strain was 0.5%, as shown in Table 37.

TABLE 37

| | Mechanical | | |
|---|---|---|---|
| | support | | Recovery |
| | strength | Viscosity | ability |
| Gel ink | 2859 Pa | 1523 Pa · s | 96% |

### (4) Printing a 3D Scaffold

CAD was used to draw a circuit line model, the model was input to an extrusion printer, parameters of the printer were set as follows: the number of printing lines at each layer of 5, a printing speed of 4 mm/s and a height of the printing layer of 1 mm, and a needle with an inner diameter of 400 μm was used; the gel ink raw material prepared in the step (1) was loaded into a syringe of the printer to print out a model scaffold. The printing was performed layer by layer to finally form a target model green body.

### (5) Performing Heat Treatment of the Model Scaffold

The model scaffold was put into a drying oven and dried at 30° C. for 12 h to obtain a cured customized inorganic non-metallic conductive scaffold. The printed scaffold was subject to cyclic voltammetry, AC impedance and Galvanostatic charge-discharge tests through an electrochemical workstation. The test results are shown in Table 38.

TABLE 38

| | | | Energy |
|---|---|---|---|
| | | Power | storage |
| | Capacitance | density | density |
| 3D scaffold | 685.4 mF/cm⁻² | 24.9 W/cm⁻³ | 51.7 μW/hcm⁻² |

### Comparative Example 8 Preparing Pure Negatively Charged Ti₃C₂Tx MXene Nanosheet Gel Ink

(1) The negatively charged Ti₃C₂Tx MXene nanosheets prepared in the step (1) of Example 22 were prepared into a suspension with a mass fraction of 5%, acetic acid was then added into the suspension, the suspension was continuously stirred for 2 h and then centrifuged at a speed of 10000 g for 60 min, supernatant fluid was then removed to obtain gel ink raw material with a solid phase content of 5 wt. %. Mechanical support strength of the gel ink was measured through the time scanning mode of a rotational rheometer, the recovery ability of the gel ink was measured through a plurality of cycles between continuous strain scanning and time scanning, and the viscosity of the gel ink was measured by changing a shear rate, as shown in Table 39.

TABLE 39

| | Mechanical | | |
|---|---|---|---|
| | support | | Recovery |
| | strength | Viscosity | ability |
| Gel ink | 968 Pa | 631 Pa · s | 89% |

### (2) Printing a 3D Scaffold

CAD was used to draw a circuit line model, the model was input to an extrusion printer, parameters of the printer were set as follows: the number of printing lines at each layer of 5, a printing speed of 4 mm/s and a height of the printing layer of 1 mm, and a needle with an inner diameter of 400 μm was used; the gel ink raw material prepared in the step (1) was loaded into a syringe of the printer to print out a model scaffold. The printing was performed layer by layer to finally form a target model green body.

### (3) Sintering the Model Scaffold

The model scaffold was put into a drying oven and dried at 30° C. for 12 h to obtain a cured customized inorganic non-metallic conductive scaffold. The printed scaffold was subject to cyclic voltammetry, AC impedance and Galvanostatic charge-discharge tests through an electrochemical workstation. The results are shown in Table 40.

TABLE 40

| | | | Energy |
|---|---|---|---|
| | | Power | storage |
| | Capacitance | density | density |
| 3D scaffold | 358 mF/cm⁻² | 16.9 W/cm⁻³ | 40.1 μW/hcm⁻² |

It can be seen from Example 22 and Comparative Example 8 that the gel ink obtained by regulating the assembly of negatively charged Ti₃C₂Tx MXene nanosheets and positively charged Ti₃C₂Tx MXene nanosheets had stronger mechanical strength and greater viscosity, which is more suitable for gel ink printing, and printed electronic devices had greater energy storage capacity.

### Example 23

### Preparing Gel Ink

The inorganic non-metallic particles prepared in each of Examples 1 to 22 were dispersed in absolute ethanol to prepare a particle suspension with a mass fraction of 10%, octadecyltrimethoxysilane was added into the suspension under stirring at 800 rpm and reacted at room temperature for 8 h, a resulting reactant was then centrifuged and washed three times with deionized water, and was dispersed into a mixture of water and ethanol (1:1), followed by stirring at 500 rpm for 30 min to obtain a precursor solution. The precursor solution was centrifuged at 10000 rpm for 30 min to obtain gel ink.

### Example 24

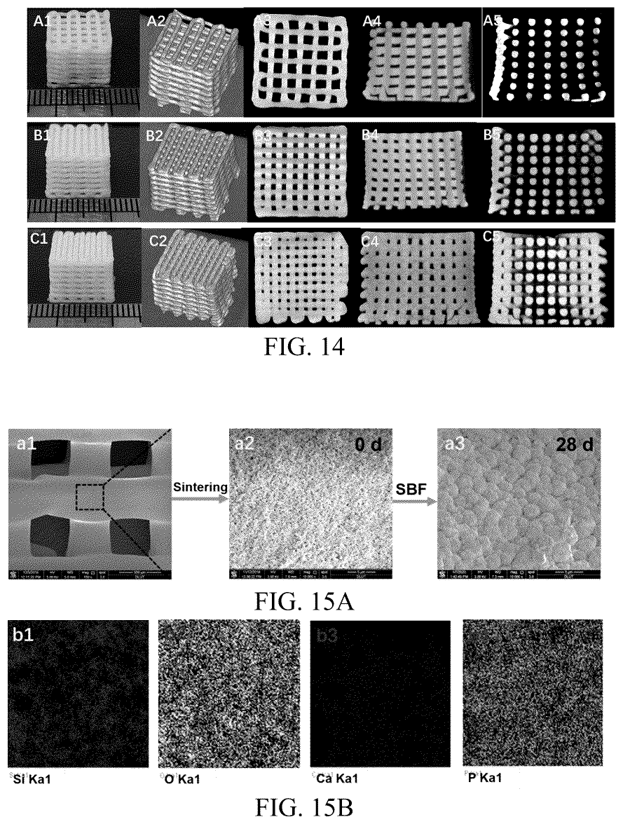

The positive/negative particles obtained in each of Examples 1 to 20 were mixed at a ratio of 2:1, and a nanostructured bio-ink with a mass fraction of 20% was obtained by centrifugal concentration. Modeling software was used to build a 15x 15x 15 mm 3D cube scaffold model, and slicing software was used to slice the 3D cube scaffold model, and the sliced model was imported into a 3D extrusion printer. The obtained nanostructured bio-ink was put into an extrusion 3D printer to print out a 3D scaffold, gaps between fibers were set to obtain 3D scaffolds with pore sizes at 0-200 μm, 200-400 μm, and 400-600 μm, as shown in FIG. 14. Panels A1 to C1 are digital images of printed scaffolds with different pore sizes, Panels A2 to C2 are Micro-CT images of scaffolds with different pore sizes, Panels A3 to C3 are top views of scaffolds with different pore sizes, Panels A4 to C4 are side views of scaffolds with different pore sizes, and Panels A5 to C5 are Micro-CT reconstruction images of scaffolds with different pore sizes. It can be seen from FIG. 14 that the printed scaffolds had complete structures and fiber direction, proving that the gel inks obtained in Examples 1-20 had good printability. After being dried at 25° C. for 24 h, the obtained 3D scaffolds were sintered to fix in a Muffle furnace at 200° C., 300° C., 500° C., and 800° C. in sequence for 2 h each, with a heating rate of 5° C./min. A mechanical testing machine was used to perform a compression test on the sintered 3D scaffolds with different pore sizes, and a compression rate was 1 mm/min, as shown in Table 41.

TABLE 41

| Pore sizes (μm) | 0-200 | 200-400 | 400-600 |
|---|---|---|---|
| Compressive strength (MPa) | 20 ± 2 | 10 ± 3 | 5 ± 1 |

### Example 25

The positive/negative particles obtained in each of Examples 1 to 20 were mixed at a ratio of 2:1, and a nanostructured bio-ink with a mass fraction of 20% was obtained by centrifugal concentration. Modeling software was used to build a 15×15×15 mm 3D cube scaffold model, and slicing software was used to slice the 3D cube scaffold model, and the sliced model was imported into a 3D extrusion printer. The obtained nanostructured bio-ink was put into an extrusion 3D printer to print out a 3D scaffold, gaps between fibers were set to obtain the 3D scaffold with a pore size of 400-600 μm. After being dried at 25° C. for 24 h, the obtained 3D scaffolds was sintered at 200° C. and 300° C. for 2 h each, and then was sintered to fix in a Muffle furnace at a final sintering temperature of one of 500° C., 600° C., 700° C., 800° C., 900° C., 1000° C., 1100° C. and 1200° C. for 2h, with a heating rate of 5° C./min. A mechanical testing machine was used to perform a compression test on the sintered 3D scaffolds with different pore sizes, and a compression rate was 1 mm/min, as shown in Table 42.

TABLE 42

| Sintering | | | | | | | | |
|---|---|---|---|---|---|---|---|---|
| temperature (° C.) | 500 | 600 | 700 | 800 | 900 | 1000 | 1100 | 1200 |
| Compressive | 2 ± 0.5 | 6 ± 1 | 8 ± 2 | 12 ± 1 | 13 ± 3 | 15 ± 2 | 17 ± 1 | 20 ± 2 |
| strength (MPa) | | | | | | | | |

### Example 26

A simulated body fluid (SBF) method are adopted to check whether the inorganic non-metallic scaffolds prepared in Examples 23 to 25 have the mineralization ability. Specific implementation steps were as follows:

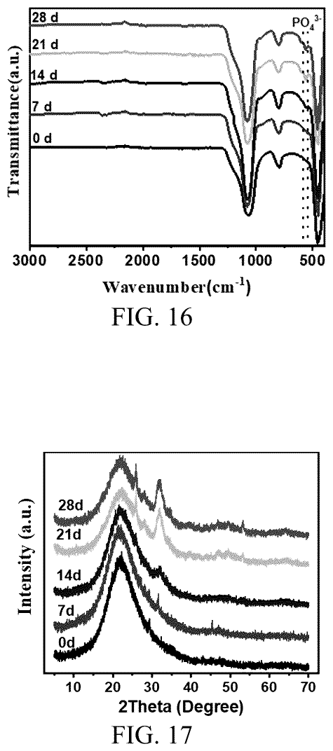

The sintered inorganic non-metallic scaffold was immersed in a 1×SBF (simulated body fluid) (pH=7.40) to evaluate their in-vitro mineralization performance. The prepared scaffold was washed several times and dried, the mass thereof was accurately weighed. A buffer solution and the scaffold were placed in a plastic jar at a ratio of 100 mL/g, and was kept on a constant temperature shaker at 37° C. and shaken at a constant speed of 90 r/min for 1, 3, 7, 14 and 21 d, the SBF was replaced every two days, and the corresponding pH value of the SBF was measured before being replaced. After the predetermined time, scaffold sample was taken out and gently washed three times with deionized water, and then was placed in a vacuum drying oven at 120° C. to fully dry. The in-vitro mineralization effect was detected through the scanning electron microscopy (SEM) and infrared testing. FIG. 15A shows SEM electron microscope images and energy spectrum scanning images of in-vitro mineralization at different time points. In FIG. 15A, panel a1 is a scanning electron microscopy image of printed scaffold fiber, panel a2 is a scanning electron microscope image of the scaffold mineralization on day 0, and panel a3 is a scanning electron microscope image of the scaffold mineralization on day 28; FIG. 15B is the distribution of Si, O, Ca, and P elements on the scaffold on day 28. The more points in the image were, the more deposition became, and it can be seen from the figures that there was a significant deposition of calcium and phosphorus elements. The accumulation of calcium and phosphorus elements proves that the inorganic non-metallic scaffolds had better in-vitro mineralization performance. FIG. 16 is an FTIR analysis chart of in-vitro mineralization at different time points, and FIG. 17 is an XDR analysis chart of in-vitro mineralization at different time points. It can be seen from the figures that amorphous calcium phosphate was formed on the surface of the scaffold as the time increased, and obvious mineralization was identified.

### Example 27

Contact culture cell experiments are performed to check whether the inorganic non-metallic scaffolds prepared in Examples 23 to 25 have cytotoxicity and in-vitro osteogenic effects. Specific implementation steps were as follows:

### (1) Taking the Culture of MC3T3-E1 Mouse Embryonic Osteoblast Precursor Cells as an Example

MC3T3-E1 mouse embryonic osteoblast precursor cells were cultured in proliferation medium (Dulbecco's Modified Eagle Medium, DMEM) for 7 d, into which 10% v/v of fetal bovine serum (FBS), 100 U/mL of penicillin and 100 g/mL of α-MEM in streptomycin were added, with culture conditions at a temperature of 37° C., 95% relative humidity and 5% CO₂, and the medium was replaced with a osteogenic medium after 1 day of culture. In order to induce osteogenesis, β-Glycerophosphate (10 mM), L-ascorbic acid (50 μg/mL) and dexamethasone (10 nM) were added to the medium as the osteogenic medium, non-adherent cells were removed, and the osteogenic medium was replaced every 3 days. During fusion, cells were washed twice with phosphate buffered saline (PBS), detached with trypsin/EDTA (0.25% w/v trypsin/0.02% EDTA) for 5 min, and revived in the culture medium.

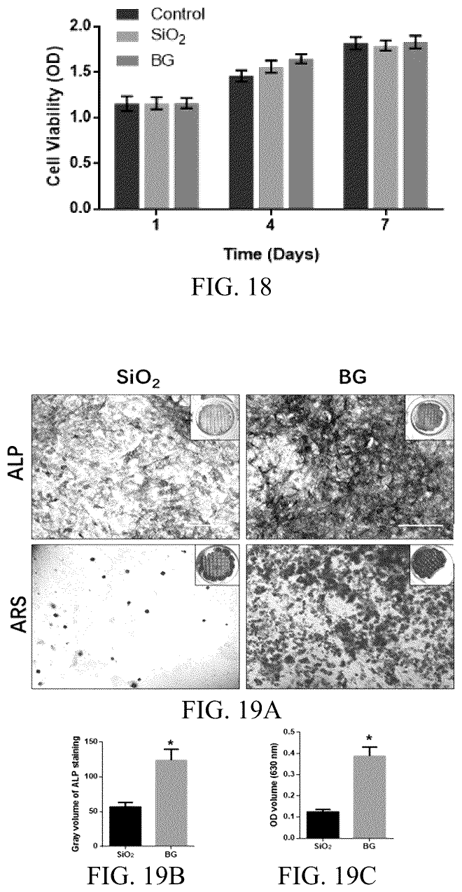

(2) The heat-treated silicon dioxide and bioglass scaffolds were sterilized by an ultraviolet lamp for 2 h, leaching liquor was prepared for the sterilized scaffolds at a concentration of 10 mg/mL, and the sterilized scaffolds were placed in the leaching liquor for leaching at 37° C. for 24 h. MC3T3-E1 in good growth condition was taken, digested and counted, a cell concentration was adjusted to be 5×10⁴ cells/mL, cells were inoculated at a concentration of 1.25 cm²/mL in each well of a 24-well plate as an experimental group, and a negative control group was set, and each group contained 6 parallel groups. After 24 h, 0.25 mg/mL of leaching liquor was added thereto. After being continuously cultured for 1 d, 2 d, and 3 d, CCK-8 was used to detect cell viability. Specifically, CCK-8 detection solution and fresh culture medium were mixed at a ratio of 1:10 to obtain a mixed solution, the cells in the 24-well plate were washed three times with the PBS solution, and 110 μL of the mixed solution was added into each well. The well-plate was stored in a thermostat in the dark and incubated for 3 h, OD value was then detected at a wavelength of 450 nm, and cell proliferation rate was calculated. The cell viability of the cells in the experimental group and the control group was shown in FIG. 18, proving that the cell viability in the scaffold leaching liquor was greater than or equaled to 100%, and the inorganic non-metallic scaffolds had good biocompatibility.

(3) In order to further evaluate osteoinductive effects of the silicon dioxide and bioglass scaffolds, ALP staining was performed by using the BCIP/NBT method. Further, Alizarin Red S (ARS) staining was performed to evaluate the mineralization of extracellular matrix (ECM). Briefly, continuously cultivating for 3 weeks after the medium was replaced with the osteogenic medium, the cell culture medium was removed, 100 μL of ARS solution was added into each well of a well-plate to hatch at 37° C. for 1 h. After image acquisition, the stained cells were treated with 10% cetylpyridinium chloride for 30 min at room temperature and tested for absorbance at 630 nm using a multimode plate reader. The results of extracellular matrix mineralization in the experimental group and the control group, including ARS and ALP staining and quantitative analysis, are shown in FIGS. 19A-19C. Specifically, FIG. 19A shows the ALP and ARS staining of SiO₂ and BG scaffolds, FIG. 19B is a quantitative image of ALP staining, and FIG. 19C is a quantitative image of ARS staining. The results shows that the silicon dioxide and bioglass scaffolds significantly promoted the osteogenesis of preosteoblast cells, and inorganic ions released from the BG scaffolds were crucial for better osteogenesis and had better mineralization effects.

### Example 28

The in-vivo osteogenesis of scaffolds is investigated by implanting inorganic non-metallic scaffolds in animals. 3-month-old (2.5-3.0 Kg) rabbits were used, and the heat-treated inorganic non-metallic scaffolds prepared in Examples 23 to 25 were sterilized by an ultraviolet lamp for 2 h. After induction of general anesthesia in the rabbits, 2 cylindrical bone defects (with a diameter of 10 mm and a height of 2 mm) were made in craniums of the rabbits, and the inorganic non-metallic scaffolds were then implanted. 3 days after the implantation operation, the rabbits were subject to the penicillin treatment and then placed in separate cages. The rabbits were euthanized 4 weeks later, and cranial parietal bones of the rabbits were collected for subsequent experiments. Micro-CT and Hematoxylin-Eosin staining were further performed.

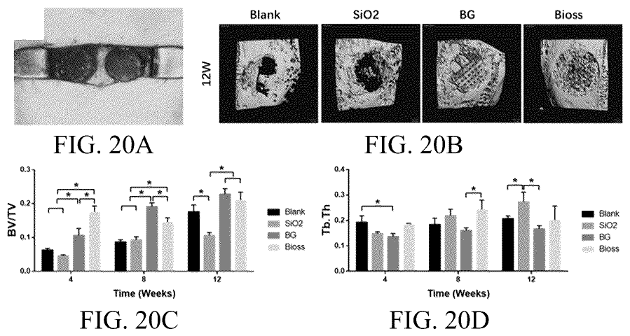

FIGS. 20A to 20D show the repair of bone defects in rabbits in Example 28 using the scaffold prepared by inorganic colloidal gel. Specifically, FIG. 20A is a digital photo of an animal model, FIG. 20B is a Micro-CT image of the repair effect of a cranial parietal bone model with SiO₂, BG and Bioss scaffolds at 12 weeks, FIG. 20C is a quantification of a new bone volume of the cranial parietal bone model with SiO₂, BG and Bioss scaffolds at 4, 8 and 12 weeks, and FIG. 20D is a quantification of a width of a new bone trabecula of the cranial parietal bone model with SiO₂, BG and Bioss scaffolds at 4, 8 and 12 weeks. The experimental operation process was shown in FIG. 20A. After the cranial parietal bone was implanted into the corresponding defect part, partial bone repair occurred at 12 weeks (FIG. 20B). The reconstruction of the cranial parietal bone by Micro-CT proved an obvious bone repair effect, and the quantification analysis of the new bone volume and the width of the new bone trabecula confirmed that the scaffolds prepared from inorganic colloid gel had good in-vivo bone repair ability.

1. An inorganic non-metallic nanoparticle-assembled hydrogel material, wherein the hydrogel material is assembled from inorganic non-metallic particles to form hydrogel network, wherein the size of the inorganic non-metallic particles ranges from 10 nm-20 μm, the inorganic non-metallic particles account for 2-80 wt. % of the total mass of hydrogel material, and the hydrogel network has microscopic pores having a pore size ranging from 0.1 μm-30 μm.

2. The inorganic non-metallic nanoparticle-assembled hydrogel material according to claim 1, wherein the hydrogel material has mechanical support strength of 100 kPa-400 kPa, viscosity of 2000-10000 Pa·s, and recovery ability after damage of 50%-100%.

3. The inorganic non-metallic nanoparticle-assembled hydrogel material according to claim 1, wherein the inorganic non-metallic particles are one or a combination of several particles of silicon dioxide particles, bioglass particles, clay particles, calcium sulfate particles, calcium carbonate particles, hydroxyapatite particles, iron oxide particles, zirconia particles, zinc oxide particles, titanium oxide particles, aluminum oxide particles, barium titanate particles, silicon carbide particles, graphene, graphene oxide, reduced graphene oxide, transition metal carbide or nitride (MXene), transition metal disulfide (TMD), hexagonal boron nitride, and black phosphorus nanosheets.

4. The inorganic non-metallic nanoparticle-assembled hydrogel material according to claim 1, wherein the preparation method of the hydrogel material is an electrostatic assembly method or a hydrophobic interaction assembly method or a magnetic interaction assembly method,
wherein,
the electrostatic assembly method comprises the following steps of:
S1. preparing negatively charged inorganic non-metallic particles by using one or more of a sol-gel method, a chemical precipitation method, a melting method, a hydrothermal method, a template method, a chemical stripping method, an electrochemical stripping method, and a mechanical stripping method, dispersing the obtained negatively charged inorganic non-metallic particles in a liquid solvent containing deionized water, preparing a particle suspension with a mass fraction of 1%-80%, and fully stirring for 2-8 h;
S2. adding the inorganic non-metallic nanoparticles to a solvent of one or a combination of methanol, ethanol, isopropanol, butanol or acetone to prepare a 1 wt. %-50 wt. % suspension, and stirring for 20-60 min and then adding water-soluble positively charged groups to react for 6-12 h, wherein the positively charged groups are amino groups in aliphatic amines, imine in nitrogen-nitrogen disubstituted amidine groups, or imine compounds in guanidine groups substituted by tetranitrogen, followed by centrifuging and washing to obtain positively charged inorganic non-metallic particles, dispersing the positively charged inorganic non-metallic particles in deionized water or in one or two of liquid solvents of methanol, ethanol, acetone and isopropanol to prepare a particle suspension with a mass fraction of 1%-80%, and fully stirring for 2-8 h to obtain a positively charged inorganic non-metallic particle suspension;
S3. adding the negatively charged inorganic non-metallic particle suspension to the positively charged inorganic non-metallic particle suspension, wherein a number ratio of the negatively charged particles to the positively charged particles in suspension is 1:0-0:1, preferably 10:1-1:50, and more preferably 5:1-1:10, to obtain a precursor solution after stirring evenly; and
S4. adding 5 mM-25 mM of an acidic solution consisting of one or more of acetic acid, phosphoric acid, hydrochloric acid and nitric acid to the precursor solution obtained in the step S3 while stirring, continuing stirring for 0.5-3 h, then centrifuging at a speed of 2000 g-10000 g for 20-40 min, and obtaining, after removing supernatant, a gel ink raw material with a solid phase content of 2-80 wt. %, which is the hydrogel material;
the hydrophobic interaction assembly method comprises the following steps of:
S1. preparing negatively charged inorganic non-metallic particles by using one or more of a sol-gel method, a chemical precipitation method, a melting method, a hydrothermal method, a template method, a chemical stripping method, an electrochemical stripping method, and a mechanical stripping method, dispersing the negatively charged inorganic non-metallic particles in absolute ethanol to prepare an inorganic non-metallic particle suspension with a concentration of 1%-80%, stirring for 20-60 min, then adding one or a combination of silicon-halogen bond compounds containing hydrophobic groups, silane coupling agent, or stearic acid compounds, to react for 6-12 h, followed by centrifuging and washing to obtain hydrophobic inorganic non-metallic particles, and dispersing the hydrophobic inorganic non-metallic particles in deionized water or in one or two of liquid solvents of methanol, ethanol, acetone and isopropanol to obtain a dispersion of the hydrophobic inorganic non-metallic particles; and
S2. centrifuging the dispersion of the hydrophobic inorganic non-metallic particles at a speed of 2000 g-10000 g for 20-40 min, and obtaining, after removing supernatant, a gel ink raw material with a solid phase content of 2-80 wt. %, which is the hydrogel material;
the magnetic interaction assembly method comprises the following steps of.
preparing magnetic particles by using one or more elements of iron, cobalt and nickel, dispersing the magnetic particles in deionized water or in one or two of liquid solvents of methanol, ethanol, acetone and isopropanol to obtain a suspension of the hydrophobic inorganic non-metallic magnetic particles with a concentration of 1%-80%, wherein the magnetic particles are oriented and assembled into a uniform network structure under the action of a magnetic field of 10-300 A/m, then centrifuging the assembled suspension at a speed of 2000 g-10000 g for 20-40 min, and obtaining, after removing supernatant, a gel ink raw material with a solid phase content of 2-80 wt %.

5. The inorganic non-metallic nanoparticle-assembled hydrogel material according to claim 1 used as bone-filling biomedical materials for injectable, shapeable and drug sustained-release carriers, wherein the inorganic non-metallic nanoparticles constituting the hydrogel are one or a combination of several particles of bioglass particles, clay particles, calcium phosphate particles, and bioactive ceramic particles, a size of the inorganic non-metallic nanoparticles is 10 nm-20 μm, and the inorganic non-metallic nanoparticles account for 2-80 wt. % of the total volume of the hydrogel.

6. An inorganic non-metallic gel scaffold, wherein the scaffold is a gel scaffold obtained through additive manufacturing the hydrogel material according to claim 1, and the gel scaffold has interpenetrating pores formed by stacking fibers, with a pore diameter of 50-1000 μm, and a porosity of 20%-80%, and a surface of the scaffold fiber has microscopic pores, with a pore diameter of 3-80 nm, a specific surface area of 50-500 m²/g, and a fracture mechanical strength of 2-25 MPa.

7. The inorganic non-metallic gel scaffold according to claim 6, wherein the preparation method of the gel scaffold comprises the following steps of:
(1) using the gel ink raw material as 3D printing ink;
(2) designing model: building a model using modeling software, and performing layered slicing processing on the built model using slicing software;
(3) performing 3D printing to form a target model green body: inputting the designed model into a printer, setting the number of printing lines and printing speed of each layer of the designed model, loading the gel ink raw material in a syringe of the printer for layer-by-layer printing, and finally forming the gel model green body; and
(4) performing heat treatment: placing the gel model green body into a sintering furnace and adjusting the sintering temperature to obtain a corresponding customized 3D porous inorganic non-metallic scaffold.

8. The inorganic non-metallic gel scaffold according to claim 7, wherein, in the step (3), the 3D printer prints fibers with a diameter ≥160 μm, a printing layer height >300 μm, and a printing speed of 0.5 mm/s-20 mm/s.

9. The inorganic non-metallic gel scaffold according to claim 7, wherein, in the step (4), the treatment temperature of the heat treatment process is determined according to properties of the scaffold, which is dried at 20-50° C. for 8-24 h and sintered at 300-1500° C. for 2-72 h, with a heating rate of 0.5-10° C./min.

10. Application of the inorganic non-metallic gel scaffolds according to claim 6 in tissue engineering or electronic devices, wherein regarding the application in tissue engineering, the inorganic non-metallic gel scaffolds are used as bone repair scaffolds, cartilage repair scaffolds, and scaffolds for loading bioactive protein drugs, bioactive substance drug molecules or mesenchymal stem cells, endothelial cells or schwann cells, and regarding the application in electronic devices, the inorganic non-metallic gel scaffolds are used as supercapacitors, batteries, solar cells, piezoelectric sensors, optoelectronic sensors, chemical sensors, biosensors, and electronic skin sensors.
